(19) United States
(12) Patent Application Publication
(10) Pub. No.: US 2020/0187505 A1
(43) Pub. Date: Jun. 18, 2020

(54) SEED, SOIL, AND PLANT TREATMENT COMPOSITIONS

(71) Applicant: RALCO NUTRITION, INC., Marshall, MN (US)

(72) Inventors: Evan Everette JOHNSON, Balaton, MN (US); Andrew Paul LANOUE, Tracy, MN (US); Rachel Ann RATHS, Marshall, MN (US); Michael David JOHNSON, Balaton, MN (US)

(21) Appl. No.: 16/613,345

(22) PCT Filed: May 15, 2018
(86) PCT No.: PCT/US2018/032736

§ 371 Date: Nov. 13, 2019

Related U.S. Application Data
(60) Provisional application No. 62/506,252, filed on May 15, 2017.

(51) Int. Cl. A01N 59/16; A01N 37/36; C05D 9/02

(52) U.S. Cl. CPC A01N 59/16; C05D 9/02; A01N 37/36

(57) ABSTRACT

Embodiments of the present disclosure describe a seed, soil, or plant treatment composition comprising a nickel compound, an iron compound, and an optional molybdenum compound. Embodiments also describe a treatment composition comprising nickel lactate. Embodiments of the present disclosure further describe a method of preparing a seed, soil, or plant treatment composition comprising contacting a compound including nickel with a carboxylic acid to form a nickel chelated compound in solution, adding one or more of an iron compound and a molybdenum compound to the solution, and mixing the solution to form a seed, soil, or plant treatment composition.

This application claims benefit of U.S. Provisional Application No. 62/506,252, filed on May 15, 2017 and which application is incorporated herein by reference. A claim of priority is made.

### BACKGROUND

Trace minerals have been found to facilitate the growth, yield, and health of agricultural crops. Such trace minerals may include chlorine, iron, boron, manganese, zinc, copper, molybdenum, sodium, silicon, nickel, and cobalt. Iron, for example, is used in chlorophyll production and therefore plays an essential role in photosynthesis, among other things. Nickel is important for activation of urease, which is an enzyme that processes urea via nitrogen metabolism. Molybdenum is a cofactor to enzymes that build amino acids for nitrogen metabolism. Formulating compositions with trace minerals, however, has proven challenging and the subject of extensive research. One challenge is providing compositions that do not reduce the bioavailability of either the trace minerals naturally existing in the soil or those minerals provided via the composition. For instance, these trace minerals may compete with other cations and thus give rise to artificial deficiencies, which may be detrimental to plant health and performance. Another challenge is ensuring the trace minerals remain readily soluble and available for plant uptake, while at the same time ensuring the concentration of those minerals also do not pose risks for human and animal consumption.

It is therefore desirable to balance these competing interests in formulating a plant treatment composition that improves plant performance.

### SUMMARY

In general, embodiments of the present disclosure describe seed, soil, and/or plant treatment compositions.

Accordingly, embodiments of the present disclosure describe a seed, soil, or plant treatment composition comprising a nickel compound, an iron compound, and optional molybdenum compounds and manganese compounds.

Embodiments of the present disclosure further describe a method of preparing a seed, soil, or plant treatment composition comprising contacting a compound including nickel with a carboxylic acid to form a nickel chelated compound in solution, adding one or more of an iron compound and a molybdenum compound to the solution, and mixing the solution to form a seed, soil, or plant treatment composition.

Embodiments also describe a seed, soil, or plant treatment composition comprising nickel lactate.

The details of one or more examples are set forth in the description below. Other features, objects, and advantages will be apparent from the description and from the claims.

### BRIEF DESCRIPTION OF DRAWINGS

This written disclosure describes illustrative embodiments that are non-limiting and non-exhaustive. In the drawings, which are not necessarily drawn to scale, like numerals describe substantially similar components throughout the several views. Like numerals having different letter suffixes represent different instances of substantially similar components. The drawings illustrate generally, by way of example, but not by way of limitation, various embodiments discussed in the present document.

Reference is made to illustrative embodiments that are depicted in the figures, in which:

FIG. 1 is a flowchart of a method of preparing a treatment composition, according to one or more embodiments of the present disclosure.

FIG. 2 is a flowchart of a method of using a seed, soil, or treatment composition in-furrow, according to one or more embodiments of the present disclosure.

FIG. 3 is a flowchart of a method of using a nickel-iron-molybdenum composition in-furrow, according to one or more embodiments of the present disclosure.

FIG. 4 is a flowchart of a method of using a treatment composition in pre-treatment of seeds, according to one or more embodiments of the present disclosure.

FIG. 5 is a flowchart of a method of using a nickel-iron-molybdenum composition in pre-treatment of seeds, according to one or more embodiments of the present disclosure.

FIG. 6 is a flowchart of a method of using a treatment composition and inorganic fertilizer mixture, according to one or more embodiments of the present disclosure.

FIG. 7 is a flowchart of a method of using a nickel-iron-molybdenum composition and inorganic fertilizer mixture, according to one or more embodiments of the present disclosure.

FIG. 8 is a flowchart of a method of using a treatment composition and herbicide mixture, according to one or more embodiments of the present disclosure.

FIG. 9 is a flowchart of a method of using a nickel-iron-molybdenum composition and herbicide mixture, according to one or more embodiments of the present disclosure.

FIG. 10 insecticide mixture, according to one or more embodiments of the present disclosure.

FIG. 11 is a flowchart of a method of using a nickel-iron-molybdenum composition and insecticide mixture, according to one or more embodiments of the present disclosure.

FIG. 12 is a flowchart of a method of using a treatment composition and biological fertilizer, according to one or more embodiments of the present disclosure.

FIG. 13 is a flowchart of a method of using a nickel-iron-molybdenum composition and biological fertilizer, according to one or more embodiments of the present disclosure.

FIG. 14 is a graphical view of two stand counts from every strip, according to one or more embodiments of the present disclosure.

FIG. 15 is a graphical view of an average of two stand counts, according to one or more embodiments of the present disclosure.

FIG. 16 is a graphical view of every data point collected for stand counts across the trial, according to one or more embodiments of the present disclosure.

FIG. 17 is a graphical view of two stand counts from every strip, according to one or more embodiments of the present disclosure.

FIG. 18 is a graphical view of an average of two stand counts, according to one or more embodiments of the present disclosure.

FIG. 19 is a graphical view of every data point collected from stand counts across the trial, according to one or more embodiments of the present disclosure.

FIG. 20 is a graphical view of leaf area of three plants in every strip for one replication, according to one or more embodiments of the present disclosure.

FIG. 21 is a graphical view of average leaf area of three plants, according to one or more embodiments of the present disclosure.

FIG. 22 is a graphical view of leaf area of three plants for every strip for one replication, according to one or more embodiments of the present disclosure.

FIG. 23 is a graphical view of average leaf area of three plants, according to one or more embodiments of the present disclosure.

FIG. 24 is a graphical view of bushel/acre change from the average of the check on both sides (2 checks total), according to one or more embodiments of the present disclosure.

FIG. 25 is a graphical view of bushel/acre change from the average of two checks on both sides (4 checks total), according to one or more embodiments of the present disclosure.

FIG. 26 is a graphical view of bushel/acre change from the slope of a third order polynomial line based off the checks, according to one or more embodiments of the present disclosure.

FIG. 27 is a scatter plot of the yield across the trial, with treatments indicated by individual colors, according to one or more embodiments of the present disclosure.

FIG. 28 is a graphical view of bushel/acre change from the average of the check on both sides (2 checks total), according to one or more embodiments of the present disclosure.

FIG. 29 is a graphical view of the bushel/acre change from the average of two checks on both sides (4 checks total), according to one or more embodiments of the present disclosure.

FIG. 30 is a graphical view of bushel/acre change from the slope of a third order polynomial line based off the checks, according to one or more embodiments of the present disclosure.

FIG. 31 is a scatter plot of the yield across the trial, with treatments indicated by individual colors, according to one or more embodiments of the present disclosure.

FIGS. 32-37 are graphical views of the yield at four sections of a research farm, according to one or more embodiments of the present disclosure.

FIG. 38 is a graphical view of plant emergence, according to one or more embodiments of the present disclosure.

FIG. 39 is a graphical view of the number of plants emerged, according to one or more embodiments of the present disclosure.

FIG. 40 is a graphical view of the unifoliate average leaf area, according to one or more embodiments of the present disclosure.

FIGS. 41-45 are graphical views of trifoliate leaf areas, according to one or more embodiments of the present disclosure.

FIG. 46 is a graphical view of the number of pods, according to one or more embodiments of the present disclosure.

FIG. 47 is a graphical view of the weight of pods, according to one or more embodiments of the present disclosure.

FIG. 48 is a graphical view of the total average soybean seed weight, according to one or more embodiments of the present disclosure.

FIG. 49 is a graphical view of the average soybean weight per pot, according to one or more embodiments of the present disclosure.

FIG. 50 is a graphical view of the average seed weight versus average pod weight, according to one or more embodiments of the present disclosure.

FIG. 51 is a graphical view of plant emergence, according to one or more embodiments of the present disclosure.

FIG. 52 is a graphical view of the number of plants emerged, according to one or more embodiments of the present disclosure.

FIGS. 53-56, 58 are graphical views of plant height, according to one or more embodiments of the present disclosure.

FIG. 57 is a graphical view of stalk diameter, according to one or more embodiments of the present disclosure.

FIG. 59 is a graphical view of leaf area, according to one or more embodiments of the present disclosure.

FIG. 60 is a graphical view of chlorophyll levels, according to one or more embodiments of the present disclosure.

FIG. 61 is a graphical view of biomass measured, according to one or more embodiments of the present disclosure.

FIG. 62 is a graphical view of plant emergence, according to one or more embodiments of the present disclosure.

FIG. 63 is a graphical view of the number of plants emerged, according to one or more embodiments of the present disclosure.

FIG. 64 is a graphical view of unifoliate average leaf area, according to one or more embodiments of the present disclosure.

FIGS. 65-69 are graphical views of trifoliate leaf areas, according to one or more embodiments of the present disclosure.

FIG. 70 is a graphical view of the number of pods, according to one or more embodiments of the present disclosure.

FIG. 71 is a graphical view of the weight of pods, according to one or more embodiments of the present disclosure.

FIG. 72 is a graphical view of the total soybean seed weight, according to one or more embodiments of the present disclosure.

FIG. 73 is a graphical view of the average soybean seed weight per pot, according to one or more embodiments of the present disclosure.

FIG. 74 is a graphical view of the average seed weight versus average pod weight, according to one or more embodiments of the present disclosure.

### DETAILED DESCRIPTION

The invention of the present disclosure relates to seed, soil, and plant treatment compositions. In particular, the invention of the present disclosure relates to seed, soil, and plant treatment compositions that may be prepared from and/or include a nickel compound(s), iron compound(s), molybdenum compound(s) and manganese compound(s). The seed, soil, and plant treatment compositions may further be prepared from and/or include additional components, including, but not limited to, one or more of a carrier, a solid carrier, a fiber, an enzyme, a pesticide, an insecticide, a fungicide, a herbicide, and a chelate or inorganic salt. The seed, soil, and plant treatment compositions can be applied alone or in combination with other components. In particular, the seed, soil, and plant treatment compositions of the present disclosure may be placed in-furrow, side-dressed in a field, used as a foliar treatment, broadcast on soil, and/or tilled in soil to improve one or more of plant emergence, crop yield, stand count, leaf area, root size, plant height, plant health, and plant resistance to disease and drought.

The seed, soil, and plant treatment compositions of the present disclosure provide concentration ranges of micronutrients that are readily available for uptake and that do not suffer from any significant reduction in the bioavailability of the micronutrients. In addition, the seed, soil, and plant treatment compositions include nickel, iron, and molybdenum compounds that are present at non-toxic concentrations. Manganese compounds can also be added in combination. Nickel, iron, molybdenum, and manganese complete the micronutrient package that provides the best nodule formation, nitrogen fixation, and metabolism benefits. In this way, the seed, soil, and plant treatment compositions of the present disclosure facilitate the bioavailability of micronutrients to maximize plant performance and minimize deleterious effects, such as toxicity. These benefits are non-exhaustive, as other benefits of the present invention are understood by persons of skill in the art.

### Definitions

The terms recited below have been defined as described below. All other terms and phrases in this disclosure shall be construed according to their ordinary meaning as understood by one of skill in the art.

The term “chelation” refers to the formation of two or more separate coordinate bonds between a polydentate (multiple bonded) ligand and a single central atom, typically a metal ion. The ligands are typically organic compounds, often in anionic form, and can be referred to as chelants, chelators, or sequestering agents. A ligand forms a chelate complex with a substrate such as a metal ion. While chelate complexes typically form from polydentate ligands, as used herein the term chelate also refers to coordination complexes formed from monodentate ligands and a central atom. Mineral chelated compositions include chelation.

A “carboxylic acid” refers to organic acids characterized by the presence of a carboxyl group, which has the formula —C(═O)OH, often written —COOH or —CO₂H. Examples of carboxylic acids include lactic acid, acetic acid, EDTA, propionic acid and butyric acid.

A “fatty acid” refers to a carboxylic acid, often with a long unbranched aliphatic tail (chain), which may be either saturated or unsaturated. Short chain fatty acids typically have aliphatic tails of six or fewer carbon atoms. Examples of short chain fatty acids include lactic acid, propionic acid and butyric acid. Medium chain fatty acids typically have aliphatic tails of 6-12 carbon atoms. Examples of medium chain fatty acids include caprylic acid, capric acid and lauric acid. Long chain fatty acids typically have aliphatic tails of greater than 12 carbon atoms. Examples of long chain fatty acids include myristic acid, palmitic acid and stearic acid. A fatty acid having only one carboxylic acid group can be a ligand of a mineral.

The term “lactic acid” refers to a carboxylic acid having the chemical structural formula of CH₃CH(OH)CO₂H. Lactic acid forms highly soluble chelates with many important minerals.

As used herein, an “inorganic mineral compound” or “mineral” refers to an elemental or compound composition including one or more inorganic species. For example, an inorganic mineral compound may be cobalt, cobalt carbonate, manganese oxide or a combination thereof. Inorganic mineral compounds may also include scandium, selenium, titanium, vanadium, chromium, manganese, iron, nickel, for example. Transition metals can also be included and salts, oxides, hydroxides and carbonates of the above mentioned compounds can be suitable inorganic mineral compounds.

As used herein, “mineral chelated compound” refers to chemical compound or mixture including at least one inorganic substance and a derivative of a carboxylic acid, or reaction product of a carboxylic acid and an inorganic mineral compound. Examples of mineral chelated compounds include but are not limited to cobalt, scandium, selenium, titanium, vanadium, chromium, manganese, iron, nickel, or a combination thereof chelated to one or more ligands to form a chelate (a chelate complex or coordinate complex). Examples of suitable ligands include lactate, acetate, propionate, butyrate, ethylene diamine, and EDTA.

As used herein, an “inorganic fertilizer” refers to a composition intended to enhance the growth of plants by providing macronutrients such as one or more of nitrogen, potassium, phosphorus, calcium, magnesium, and sulfur. The inorganic fertilizer typically does not include significant amounts of living organisms. Inorganic fertilizers often include micronutrients, such as boron, chlorine, iron, manganese, molybdenum. Inorganic fertilizers can also include optional ingredients such as greensand or rock phosphate. The inorganic fertilizer can be, for example, an NPK fertilizer, a known commercial fertilizer, or the like.

As used herein, “biological fertilizer”, “natural fertilizer” or “organic fertilizer” refers to a fertilizer that includes living organisms, or plant or animal matter. A biological fertilizer can include components such as manure, blood meal, alfalfa meal, seaweed, or compost. The fertilizers can be provided in a variety of granular or liquid forms.

As used herein, “pesticide” refers to a composition or product that kills or repels plant or seed pests, and may be broken into a number of particular sub-groups including, but not limited to, acaricides, avicides, bactericides, fungicides, herbicides, insecticides, miticides, molluscicides, nematicides, piscicides, predacides, rodenticides, and silvicides. Pesticides may also include chemicals which are not normally used as pest control agents, such as plant growth regulators, defoliants, and desiccants, or which are not directly toxic to pests, such as attractants and repellants. Some microbial pesticides may be bacteria, viruses, and fungi that cause disease in given species of pests. Pesticides may be organic or inorganic. Pesticides applied to plant seeds may remain on the surface of the seed coat following application, or may absorb into the seed and translocate throughout the plant.

As used herein, “herbicide” refers to a composition or product that kills or deters weed growth. One example of an herbicide includes glyphosate (i.e., RoundUp® herbicide).

As used herein, “insecticide” refers to a composition or product that kills or repels insects. Examples of insecticides include Sevin (carbaryl), permethrin, and Bacillus thruingiensis.

As used herein, “foliar” refers to the foliage of a plant or crop, or applying to the foliage of a plant or crop.

As used herein, “in-furrow” refers to applying a substance within a planting furrow in contact with or in near proximity to a seed. In-furrow application can occur before a seed is planted, simultaneous with seed planting, or after seed planting.

As used herein, “genetically modified plant” or “genetically modified organism” refers to an organism whose genetic material has been altered using genetic engineering techniques such as recombinant DNA technology.

As used herein, “rapidly soluble mineral chelated product” refers to a mineral chelated compound that has been altered to increase solubility in a solvent. Altering may include reducing in size, filtering, screening or chemically reacting. An inorganic mineral compound may be organically chelated such that its solubility changes from insoluble to soluble in a chosen solvent.

As used herein, “solution” refers to a homogeneous or substantially homogeneous mixture of two or more substances, which may be solids, liquids, gases or a combination thereof.

As used herein, “mixture” refers to a combination of two or more substances in physical or chemical contact with one another.

The term “contacting” refers to the act of touching, making contact, or of bringing to immediate or close proximity, including at the cellular or molecular level, for example, to bring about a physiological reaction, a chemical reaction, or a physical change, e.g., in a solution, in a reaction mixture, in vitro, or in vivo. Accordingly, treating, tumbling, vibrating, shaking, mixing, and applying are forms of contacting to bring two or more components together.

As used herein, “adding” refers to bringing into contact two or more components. In many embodiments, “adding” refers to “contacting,” as that term is defined above.

As used herein, “mixing” refers to one or more of mixing, stirring, agitating, vibrating, shaking, turning, spinning, and/or other conventional techniques known in the art to facilitate and/or achieve contacting, as that term is defined above.

As used herein, “applying” refers to bringing one or more components into nearness or contact with another component. Applying can refer to contacting or administering.

As used herein, “pre-treatment” or “seed treatment” refers to chemically and/or physically contacting seeds with a composition prior to planting.

As used herein, “reacting” refers to undergoing a chemical change. Reacting may include a change or transformation in which a substance oxidizes, reduces, decomposes, combines with other substances, or interchanges constituents with other substances.

As used herein, “transferring” refers to moving a component or substance from one place or location to another.

As used herein, “mold” refers to a hollow form or matrix for shaping a fluid, gel, semi-solid or plastic substance.

As used herein, “filtering” or “filtration” refers to a mechanical method to separate solids from liquids, or separate components by size or shape. This can be accomplished by gravity, pressure or vacuum (suction).

As used herein, “carrier” refers to a substance that physically or chemically binds or combines with a target or active substance to facilitate the use, storage or application of the target or active substance. Carriers are often inert materials, but can also include non-inert materials when compatible with the target or active substances. Examples of carriers include, but are not limited to, water for compositions that benefit from a liquid carrier, or diatomaceous earth for compositions that benefit from a solid carrier.

As used herein, “substrate” refers to a base layer or material on which an active or target material interacts with, is applied to, or acts upon.

As used herein, “stoichiometric” or “stoichiometric amounts” refer to starting materials of a reaction having molar amounts or substantially molar amounts such that the reaction product is formed with little to no unused starting material or waste. A stoichiometric reaction is one in which all starting materials are consumed (or substantially consumed) and converted to a reaction product or products.

As used herein, “adherent” refers to a material, such as a polymer, that facilitates contact or binding of one or more chemicals with a seed during a seed-pre-treatment process.

As used herein, “enzymes” refers to one or more biological molecules capable of breaking down cellulosic material.

As used herein, “treatment compositions” refers to a seed, soil, and/or plant treatment composition as described herein.

As used herein, “nickel-iron-molybdenum treatment composition” refers to a treatment composition including, but not limited to, one or more nickel compounds, one or more iron compounds, and one or more molybdenum compounds. In many embodiments, additional components and/or compounds may be further included in the nickel-iron-molybdenum treatment compositions.

As used herein, “Generate” or “Gen” refers to a seed, soil, or plant treatment composition including one or more minerals, wherein one or more of the minerals may be present as a mineral chelated compound or inorganic mineral compound. The minerals may include, among others, one or more of cobalt, scandium, selenium, titanium, vanadium, chromium, manganese, iron, nickel, copper, and zinc. The chelate may include, among others, one or more of lactate, acetate, propionate, butyrate, ethylene diamine, and EDTA. The inorganic mineral compound may include, among others, one or more of carbonate, gluconate, sulfate, oxide, and hydroxide. The seed, soil, or plant treatment composition may optionally further include one or more of emulsifiers and fibers, such as soluble fibers.

Embodiments of the present disclosure describe a seed, soil, or plant treatment composition comprising a nickel compound, an iron compound, and optional molybdenum compound. Manganese compounds can also be combined. Embodiments herein also disclose a nickel lactate compound as a seed, soil, or plant treatment composition. In many embodiments, the seed, soil, and plant treatment composition may be prepared from the nickel compound, iron compound, and molybdenum compound.

The nickel compound may include a nickel source that can supply a plant with nickel in any form and/or oxidation state. In many embodiments, the nickel compound includes one or more nickel chelated compounds. To form one or more nickel chelated compounds, a compound containing nickel may be contacted with a carboxylic acid. The compound containing nickel may include nickel hydroxyl-carbonate paste or any other compound containing nickel capable of providing nickel to form a nickel chelated compound. The carboxylic acid may include one or more of lactic acid, sulfuric acid, EDTA, propionic acid, butyric acid, and acetic acid. The nickel chelated compound may include one or more of a nickel lactate compound, a nickel sulfate compound, a nickel ethyelenediamine tetraacetate compound, a nickel propionate compound, a nickel butyrate compound, a nickel acetate compound, and variations thereof. The chelated portion of the nickel chelated compound may include one or more of lactate, ethylenediamine tetraacetate (EDTA), propionate, butyrate, and acetate. In other embodiments, the nickel compound may include one or more of nickel lignosulfonate, nickel gluconate, nickel sulfamate tetrahydrate, nickel acetate tetrahydrate, anhydrous nickel salts, hydrated nickel sulfate, hydrated nickel nitrate, and hydrated nickel chloride.

In many embodiments, the nickel compound and/or nickel chelated compound is nickel lactate, nickel sulfate, or combinations thereof. In some embodiments, nickel lactate and nickel sulfate are both included in the treatment composition. At least one reason for providing both nickel lactate and nickel sulfate in the treatment composition is to provide the plant with a source of nickel once uptake of nickel lactate and/or nickel sulfate is about exhausted or exhausted. For example, plant uptake of nickel lactate may occur first, with limited or no uptake of nickel sulfate. Once nickel lactate is depleted or nearly depleted, plant uptake of nickel sulfate may then occur. Alternatively, plant uptake of nickel sulfate may occur first, with limited or no uptake of nickel lactate. Once nickel sulfate is depleted or nearly depleted, plant uptake of nickel lactate may then occur. Other nickel compounds and/or nickel chelated compounds disclosed herein may be used in place of nickel lactate and/or nickel sulfate to achieve the same “time releasing” effect. In other embodiments, the nickel compound of the plant treatment composition may include only nickel lactate or only nickel sulfate.

The iron compound may include an iron source that can supply a plant with iron in any form and/or oxidation state. In many embodiments, the iron compound is ferric ammonium citrate. In other embodiments, the iron compound may include one or more iron chelated compounds. The one or more iron chelated compounds may include one or more of an iron lactate compound, an iron sulfate compound, an iron ethyelenediamine tetraacetate compound, an iron propionate compound, an iron butyrate compound, an iron acetate compound, and variations thereof. The chelated portion of the iron chelated compound may include one or more of lactate, sulfate, ethylenediamine tetraacetate (EDTA), propionate, butyrate, and acetate. In another embodiment, the iron compound may include one or more of ferric citrate, ferric chloride, ferrous sulfate, and ferrous sulfate heptahydrate.

As provided above, in many embodiments, the iron compound is ferric ammonium citrate. Ferric ammonium citrate, when compared to other iron compounds, such as the iron chelated compounds, is preferably included in the plant treatment composition. For example, in some instances, the chelate portion (e.g., EDTA) of the iron chelated compound may form a strong bond to iron that reduces iron's bioavailability. In other instances, iron from a strongly chelated iron compound may be bioavailable (e.g., once solubilized), but the chelate portion may then strongly bind to other nutrients that reduces those nutrients' bioavailability. In addition, ferric ammonium citrate is a highly stable and highly soluble form of iron that increases iron's bioavailability to a plant.

The molybdenum compound may include a molybdenum source that can supply a plant with molybdenum. In many embodiments, the molybdenum compound is one or more of ammonium molybdate (e.g., ammonium molybdate (IV), tetrahydrate) or molybdic acid. In other embodiments, the molybdenum compound may include one or more molybdenum chelated compounds. The one or more molybdenum chelated compounds may include one or more of a molybdenum lactate compound, a molybdenum sulfate compound, a molybdenum ethyelenediamine tetraacetate compound, a molybdenum propionate compound, a molybdenum butyrate compound, a molybdenum acetate compound, and variations thereof. The chelated portion of the molybdenum chelated compound may include one or more of lactate, sulfate, ethylenediamine tetraacetate (EDTA), propionate, butyrate, and acetate. In another embodiments, the molybdenum compound may include one or more of sodium molybdate, molybdenum trioxide, calcium molybdate, potassium molybdate, and combinations thereof.

The manganese source compound may include a manganese source that can supply a plant with manganese. In other embodiments, the manganese compound may include one or more manganese chelated compounds. The one or more manganese chelated compounds may include one or more of a manganese lactate compound, a manganese sulfate compound, a manganese ethyelenediamine tetraacetate compound, a manganese propionate compound, a manganese butyrate compound, a manganese acetate compound, and variations thereof. The chelated portion of the manganese chelated compound may include one or more of lactate, sulfate, ethylenediamine tetraacetate (EDTA), propionate, butyrate, and acetate. Manganese can also be provided as oxides or as salts. When in tank with glyphosate, manganese lactate is the preferred form to reduce any risk of chemical interaction.

While nickel, iron, molybdenum, and manganese are generally known as plant micronutrients or trace minerals, a plant may be provided with nickel, iron, and/or molybdenum below a threshold level. For instance, high concentrations of nickel may be toxic to plants. In addition, high concentrations of molybdenum may be harmful to animals feeding on the plants. Moreover, each of nickel, iron, and/or molybdenum and manganese present in the treatment composition may not be soluble above threshold levels (e.g., concentrations, volume, mass, etc.), thereby reducing each of nickel, iron, and/or molybdenum's bioavailability to a plant. For example, at least one challenge with iron is that it is not always present in a soluble form and/or available (e.g., bioavailable) for plant uptake. At least one feature of the present invention is that the plant treatment compositions include novel concentration ranges of nickel, iron, and/or molybdenum that balance these competing considerations.

The concentration of the nickel compound may range from about 0.001 wt. % to about 10 wt. %, or preferably from about 2 wt. % to about 8 wt. %. In some embodiments, where the concentration of the nickel compound is above about 10 wt. %, the nickel compound is not soluble. Accordingly, in many embodiments, the concentration of the nickel compound is less than about 10 wt. %, less than about 6 wt. %, less than about 4 wt. %, or less than about 2 wt. %. In some embodiments in which the nickel compound includes nickel lactate and nickel sulfate, the concentration of nickel lactate may be less than about 3 wt. %, less than about 2 wt. %, or less than about 1 wt. %, and the concentration of nickel sulfate may be less than about 6 wt. %, less than about 4 wt. %, or less than about 3 wt. %. In other embodiments, the concentration of nickel in the plant treatment composition is less than about 3 wt. %, less than about 2 wt. %, or less than about 1 wt. %. In some embodiments, the concentration of nickel hydroxyl-carbonate paste may be about 0.70 wt. % and the concentration of nickel sulfate may be about 1.3 wt. %. Notwithstanding the above ranges, any suitable concentration range may be used that is not toxic to the plant and/or that does not render the nickel compound insoluble. For example, in other embodiments, concentrations of the nickel compound and/or nickel in the plant treatment composition may equal to or exceed about 10 wt. %.

The concentration of the iron compound may range from about 0.001 wt. % to about 60 wt. %. In some embodiments, where the concentration of the iron compound is above about 60 wt. %, the iron compound is not soluble. Accordingly, in many embodiments, the concentration of the iron compound is less than about 60 wt. %, less than about 50 wt. %, less than about 40 wt. %, less than about 30 wt. %, less than about 20 wt. %, less than about 10 wt. %, less than about 1 wt. %. In embodiments in which the iron compound includes ferric ammonium citrate, the concentration of ferric ammonium may be about 30 wt. %. In other embodiments, the concentration of iron in the plant treatment composition may be less than about 14 wt. %, less than about 13 wt. %, less than about 12 wt. %, less than about 11 wt. %, less than about 10 wt. %, less than about 9 wt. %, less than about 8 wt. %, less than about 7 wt. %, less than about 6 wt. %, less than about 5 wt. %, less than about 4 wt. %, less than about 3 wt. %, less than about 2 wt. %, or less than about 1 wt. %. Notwithstanding the above ranges, any suitable concentration range may be used that does not render the iron compound insoluble. For example, in other embodiments, concentrations of the iron compound and/or iron in the plant treatment composition may equal to or exceed about 60 wt. %.

The concentration of the molybdenum compound may range from about 0.001 wt. % to about 2 wt. %. In some embodiments, where the concentration of the molybdenum compound is above about 2 wt. %, the molybdenum is not soluble. Accordingly, in many embodiments, the concentration of the molybdenum compound is less than about 2 wt. %, less than about 1.5 wt. %, less than about 1.2 wt. %, or less than about 0.6 wt. %. In embodiments in which the molybdenum compound includes one or more of ammonium molybdate and molybdic acid, the concentration of the ammonium molybdate and/or molybdic acid may be about less than 1.2 wt. %, or about less than 0.6 wt. %. In other embodiments, the concentration of molybdenum in the plant treatment composition may be less than about 0.6 wt. % or less than about 0.3 wt. %. Notwithstanding the above ranges, any suitable concentration range may be used that does not render the molybdenum compound insoluble. For example, in other embodiments, concentrations of the molybdenum compound and/or molybdenum in the plant treatment concentration may be equal to or exceed about 2 wt. %.

The concentration of the manganese compound may range from about 0.001 wt. % to about 3 wt. %. In many embodiments, the concentration of the manganese compound is less than about 2 wt. %, less than about 1.5 wt. %, less than about 1.2 wt. %, or less than about 0.6 wt. %. Notwithstanding the above ranges, any suitable concentration range may be used that does not render the manganese compound insoluble. For example, in other embodiments, concentrations of the manganese compound and/or manganese in the plant treatment concentration may be equal to or exceed about 1.5 to about 2.5 wt. %.

The compositions can be prepared using carriers. Carriers are ideally inert materials that do not react with the active components of the composition chemically, or bind the active components physically by absorption or adsorption. Liquid carriers may include pure water, such as reverse osmosis water, or other liquids, such as crop oils or surfactants which are compatible with the composition and plant tissue. The composition may be at least about 50% water by weight, at least about 65% water by weight, at least about 75% water by weight, at least about 85% water by weight, or at least about 90% water by weight. In some embodiments, the composition will be about 60% to about 70% water, 80% to about 99% water, about 85% to about 98% water, about 90% to about 95% water, or about 91% to about 94% water.

In some other compositions it is preferable to use solid carriers, such as diatomaceous earth, finely ground limestone (CaCO₃), or magnesium carbonate (MgCO₃). Sugars such as sucrose, maltose, maltodextrin, or dextrose may also be used as solid carriers. In other compositions, it is beneficial to use a combination of solid and liquid carriers.

The composition may also include a fiber, for example, a fiber that can act as a food source for beneficial bacteria in soil or another growth medium. Fiber can also act as an adherent. Soluble fibers are preferred as they generally enhance product efficacy and stability by keeping less soluble materials in solution or suspension due to their inherent charge and ability to disperse other charged components in solution. Soluble fibers also allow for higher composition-to-seed adhesion in pre-treatment. Fiber content within the composition is adjustable to better maintain less soluble materials in solution or suspension, and to modify composition “stickiness”. Higher fiber content and “stickiness” is often desirable in seed pre-treatments in order to ensure sufficient composition binding to and coverage of the seeds. Fiber content and type can also be modified to control composition-seed adhesion time, and adhesion strength. Because seeds can be pre-treated off-site and must be transported to farms, adhesion strength is important to ensure that pre-treatment compositions do not shake, rub, or fall off the seeds during processing, shipping, storage, or planting. The higher fiber content and overall concentration of pre-treatment compositions in comparison foliar and in-furrow application compositions may increase composition density. Lower fiber content may be preferable for liquid foliar or in-furrow application compositions, which ideally have lower percent solids and viscosities to allow for easier transport and application, and to minimize equipment clogging. Suitable and effective fibers include hemicellulose, for example, the hemicellulose extracted from Larch trees. Another example of a suitable fiber is a yucca plant extract, commercially available as Saponix 5000 or BioLiquid 5000.

The composition can further include one or more enzymes, including a blend of enzymes. The enzymes can serve to break down cellulosic material and other material, including stover left on a field after harvest. Useful and beneficial enzymes include enzymes which break down starch, such as amylases, enzymes which break down protein, such as proteases, enzymes which break down fats and lipids, such as lipases, and enzymes which break down cellulosic material, such as cellulases.

The composition can also include one or more compatible herbicides, such as glyphosate. The composition can include many different types of fungicides, which may contain active ingredients including but not limited to: chlorothalonil, copper hydroxide, copper sulfate, mancozeb, flowers of sulfur, cymoxanil, thiabendazole, captan, vinclozolin, maneb, metiram, thiram, ziram, iprodione, fosetyl-aluminum, azoxystrobin, and metalaxyl. The composition can include many different types of insecticides, which may contain active ingredients including but not limited to: aldicarb, acephate, chlorpyrifos, pyrethroids, malathion, carbaryl, sulfuryl fluoride, naled, dicrotophos, phosmet, phorate, diazinon, dimethoate, azinphos-methyl, endosulfan, imidacloprid, and permethrin. The composition can include many different types of herbicides, which may contain active ingredients including but not limited to: diuron, 2-methyl-4-chlorophenoxyacetic acid (MCPA), paraquat, dimethenamid, simazine, trifluralin, propanil, pendimenthalin, metolachlor-S, glyphosate, atrazine, acetochlor, “2,4-D”, methylchlorophenoxypropionic acid (MCPP), pendimethalin, dicamba, pelarganoc acid, triclopyr, monosodium methyl arsenate (MSMA), sethoxydim, quizalofop-P, primisulfuron, imazamox, cyanazine, bromoxylin, s-ethyl dipropylthiocarbamate (EPTC), glufosinate, norflurazon, clomazone, fomesafen, alachlor, diquat, and isoxaflutole.

The composition can be prepared with and/or combined with an in-furrow treatment composition. The in-furrow treatment composition may include a mineral chelated compound and a mineral salt. For example, the mineral of the mineral chelated compound may include a mineral, such as one or more of cobalt and manganese. The chelate of the mineral chelated compound may include lactate and an anion of the mineral salt compound may include sulfate. In many embodiments, the in-furrow treatment composition may include one or more of a cobalt lactate, cobalt sulfate, ferric ammonium citrate, manganese lactate, an emulsifier, a surfactant (e.g., Saponix 5000), and a soluble fiber (e.g., liquid arabinogalactan).

In one embodiment, the composition is prepared to provide high percentages of aqueous soluble minerals. Additional optional components include forms of soluble calcium, boric acid, and the like.

In some embodiments, the composition includes a carrier, a nickel compound, an iron compound, a molybdenum compound, additional chelated or inorganic salts, soluble fiber, and enzymes. Some exemplary chelated or inorganic salts particular to this embodiment include salts of scandium, selenium, titanium, vanadium, chromium, manganese, iron, nickel, molybdenum, or combinations thereof.

In some embodiments, the composition can contain up to 98% carrier, such as water, 0-40% of one or more of nickel, iron, and molybdenum compounds, 0-60% of one or more exemplary chelated or inorganic salts, 0-15% fiber, and 0-0.1 enzymes. In some such embodiments the fiber can be soluble.

Another composition that can be used to treat seeds, plants, and soil is a dry mixture of components that can be applied as a powder to a desired target (e.g., seed, plants, or soil). Components that can be included in such a composition include a nickel compound, iron compound, molybdenum compound, dextrose, manganese sulfate, yucca extract, hemicellulosic fiber, and enzymes capable of digesting cellulosic fiber.

Another composition that can be used to treat seeds, plants, and soil is a treatment composition that includes a nickel compound, iron compound, and molybdenum compound and various other components such as fiber and enzymes. A treatment composition of the invention can be an aqueous solution or aqueous dispersion or suspension.

In one embodiment, a composition can include about 85% to about 95% water, nickel lactate and/or nickel sulfate, ferric ammonium citrate, ammonium molybdate or molybdic acid, cobalt lactate, iron-EDTA or iron lactate, manganese-EDTA or manganese lactate, soluble hemicellulosic fiber, and enzymes that can facilitate the degradation of cellulosic material.

In some embodiments, the composition may include water, nickel lactate, nickel sulfate, ferric ammonium citrate, and ammonium molybdate (e.g., ammonium molybdate (IV), tetrahydrate). In some embodiments, the composition may further include molybdic acid.

In some embodiments, the composition may include water, nickel lactate, nickel sulfate, ferric ammonium citrate, and molybdic acid. In some embodiments, the composition may further include ammonium molybdate (e.g., ammonium molybdate (IV), tetrahydrate).

In some embodiments, the composition may include water, nickel lactate, ferric ammonium citrate, and ammonium molybdate (e.g., ammonium molybdate (IV), tetrahydrate). In some embodiments, the composition may further include molybdic acid.

In some embodiments, the composition may include water, nickel lactate, ferric ammonium citrate, and molybdic acid. In some embodiments, the composition may further include ammonium molybdate (e.g., ammonium molybdate (IV), tetrahydrate).

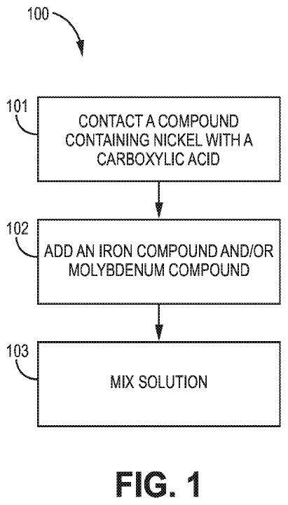

FIG. 1 is a flowchart of a method 100 of preparing a seed, soil, or plant treatment composition comprising contacting 101 a compound including nickel with a carboxylic acid to form a nickel chelated compound in solution, adding 102 one or more of an iron compound and a molybdenum compound to the solution, and mixing 103 the solution. Optionally, any of the additional components described herein may be added before, during, and/or after steps 101, 102, and/or 103. For example, one or more of a carrier, solid carrier, fiber, enzyme, pesticide, fungicide, insecticide, herbicide, chelated or inorganic salts, and any other component described herein may be added and/or combined before, during, and/or after any of steps 101, 102, and/or 103.

At step 101, the compound including nickel may be contacted with a carboxylic acid to form a nickel chelated compound in solution. In many embodiments, the compound containing nickel (e.g., nickel hydroxy-carbonate paste (about 40% nickel)) and the carboxylic acid (e.g., lactic acid) are added to water to facilitate the contacting. The volume of water may be about half of the total volume of water to be included. The solution may be reacted over a period of time, sufficient to provide a nickel chelated compound. The solution may be stirred for a period of time (e.g., about 1 hour) and heated to a temperature (e.g., 80° F. to 100° F.).

Carboxylic acid may be contacted with the compound containing nickel, such as by mixing, stirring, agitating, vibrating, shaking, turning, spinning, and/or other conventional techniques known in the art for contacting. If the carboxylic acid is lactic acid, the carboxylic acid content may be about 0.01% to about 10% of the mixture by weight. The compound containing nickel may include about 0.01% to about 3% of the mixture by weight. More specifically, the lactic acid may include about 1.8% to about 7.5% and the compound containing nickel may include about 0.7% to about 2.8% of the mixture by weight.

The carboxylic acid and compound containing nickel may be placed in a vessel, optionally with one or more catalysts. Examples of a catalyst include iron and alkaline earth metals. The vessel may be optionally agitated, such as by vibrating, shaking, turning, or spinning, or the solution mixed or stirred. Water may be added to the vessel before, during, or after the contacting of the carboxylic acid with the compound containing nickel. Once a solution is formed, it may be reacted over a period of time. The reaction may initiate based solely on the contact between carboxylic acid and the compound containing nickel, after addition or contact with a catalyst or similarly with the contact or addition of water of some combination thereof. Depending on the type of compound containing nickel utilized, carbon dioxide may be evolved as the solution heats up. Both water vapor and optionally carbon dioxide may be generated and released from the vessel. In some embodiments, no reflux process is needed or desired, as often used conventionally with regard to related reactions. By-products may be passively and naturally removed, without the need for solvent removal or refluxing. Carbon dioxide and water may be released to the atmosphere, for example.

Once the compound containing nickel and carboxylic acid are allowed to react over a period of time, the formation of a nickel chelated compound may be confirmed by observing the solution. In some embodiments, once the nickel chelated compound is formed, the solution may be clear or about clear.

At step 102, an iron compound and molybdenum compound may be added to the solution. The remaining water to be added to the solution may be provided before, during, or after the iron compound and molybdenum compound are added to the solution. In some embodiments, another nickel compound may be added to the solution. For example, in some embodiments, nickel sulfate may be added to the solution. Upon adding one or more of an iron compound, molybdenum compound, and nickel compound, the solution may be mixed and/or reacted over a period of time (e.g., about 20 to about 30 minutes) to form the treatment composition.

At step 103, the solution is mixed. Mixing the solution may include one or more of mixing, stirring, agitating, shaking, turning, spinning, and/or other conventional techniques known in the art to facilitate and/or achieve contacting. In many embodiments, the solution may be mixed for a period of time, for example, such as for about 20 minutes to about 30 minutes.

The treatment compositions of the present disclosure provide flexibility and control over numerous applications. The treatment compositions may be combined, mixed, and/or contacted with any of the other components (e.g., components other than a nickel compound, iron compound, and molybdenum compound), including those disclosed herein and those not disclosed herein, to achieve the benefits of the treatment composition of the present disclosure in addition to the benefits provided by the other components (e.g., such as a fertilizer, pesticide, etc.). It may be desirable to vary the components to be combined, mixed, and/or contacted with the treatment composition of the present disclosure over time and/or over the course of a season. For example, some components may be more desirable early in a season and other components may be more desirable later in a season (e.g., before harvesting). In addition, the treatment compositions of the present disclosure may be combined with other components in either a liquid form and/or a solid form.

Many embodiments relate to compositions that can be used to treat seeds, plants, and soil include mixtures having natural, organic, inorganic, or biological fertilizers, or combinations thereof, with one or more compatible pesticides. These compositions may also contain enzymes, fibers, water, and minerals as discussed above. Such mixtures ensure or enhance seed germination and plant growth, health, and yield while protecting seeds and plants from infection or infestation and harsh conditions, such as drought. Seed pre-treatment has shown to be beneficial for a number of reasons. In general, seed pre-treatment will create a zone of pest suppression after planting in the immediate area of the seed. As a result, fewer pesticide application trips are required, which minimizes physical damage to plants, reduces application and handling costs, and cuts down on pesticide drift problems.

For some pests, such as fungal diseases, protectant seed treatments are preferable to post-infestation or post-infection treatments because the pathogens live in such close association with host plants that it can be difficult to kill the pest without harming the host. Other types of fungicidal seed pre-treatments include seed disinfestation, which controls spores and other forms of disease organisms on the seed surface, and seed disinfection, which eliminates pathogens that have penetrated into the living cells of the seed.

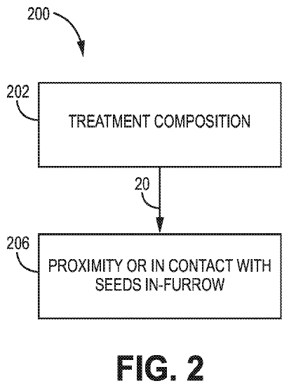

FIG. 2 is a flowchart of a method 200 of using a treatment composition in-furrow, according to one or more embodiments of the present disclosure. One or more treatment compositions 202 can be applied 204 in proximity or in-contact with one or more seeds in-furrow 206. In order to save a farmer time and increase efficiency, one or more treatment compositions 202 can be simultaneously or near-simultaneously placed in-furrow during planting. In-furrow fertilizers can be applied within proximity to a seed or in contact with a seed to promote more vigorous seedling growth by providing immediate nutrient supply to the plant roots. Proximity of in furrow fertilizer to seeds is determined based fertilizer compositions, such as ammonia and salt content that may be toxic to young seedlings. Soil type can also affect in-furrow fertilization efficacy as dryer, sandier soils can exacerbate root zone drying. Maintaining higher moisture content in soil can improve crop response to in-furrow fertilization by alleviating the effects of salt and ammonia. In addition to in-furrow, the mineral chelated compound can be introduced in a side-dress application, tilled in soil as a soil surface application, and combinations thereof. A nickel-iron-molybdenum composition is an example of a treatment composition that can be placed in-furrow with a plant seed without risk or harm or incompatibility with the seeds or proximate chemical treatments.

In-furrow application compositions can be solids, homogenous liquids, or heterogeneous slurries. Liquid or slurry application compositions may be preferable as they can be applied using common agricultural sprayers and other like equipment. In many embodiments, the treatment compositions are provided in liquid form.

The treatment composition can include one or more nickel compounds, one or more iron compounds, and/or one or more molybdenum compounds. The treatment composition can also include one or more enzymes, carriers, fiber, or a combination thereof. Examples of such compounds and methods of making are described in co-owned U.S. patent application Ser. No. 12/835,545. These treatment compositions may include any of the components and/or compounds described herein and thus shall not be limiting.

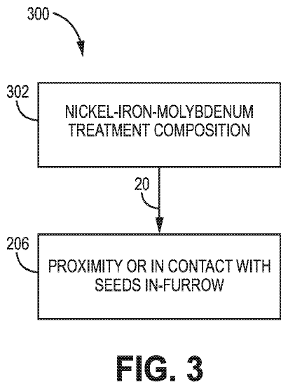

FIG. 3 is a flowchart of a method 300 of using a nickel-iron-molybdenum composition in-furrow, according to one or more embodiments of the present disclosure. The nickel-iron-molybdenum treatment composition 302 can be applied 204 in proximity or in-contact with one or more seeds in-furrow 206.

Examples of nickel-iron-molybdenum treatment compositions 302 include one or more of a nickel compound, an iron compound, and a molybdenum compound. For example, the nickel-iron-molybdenum treatment compositions may include and/or may be prepared from one or more of a nickel chelated compound, iron chelated compound, and/or molybdenum compound. In addition, the nickel-iron-molybdenum treatment compositions may include one or more of nickel lactate, nickel sulfate, ferric ammonium citrate, ammonium molybdate, and molybdic acid. Other components and/or compounds described herein may be added to the nickel-iron-molybdenum treatment compositions and/or the nickel-iron-molybdenum treatment compositions may be combined with any of the other components and/or compounds described herein. The other components and/or compounds may include one or more of a carrier, solid carrier, fiber, enzyme, pesticide, fungicide, insecticide, herbicide, and chelated or inorganic salts.

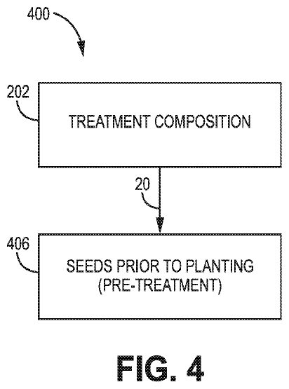

FIG. 4 is a flowchart of a method 400 of using a treatment composition in pre-treatment of seeds, according to one or more embodiments of the present disclosure. The treatment composition 202 can be applied 204 to one or more seeds prior to planting, such as in a pre-treatment stage 406.

Seed pre-treatment pesticides can be applied as dusts, but are often homogenous solutions or heterogenous slurries or suspensions. Seed treatment or pretreatment 406 can be accomplished within a seed bag or by mechanical means, such as in a tumbler. The one or more seeds can be agitated after applying 204. Agitating can include tumbling, vibrating, mixing, shaking, and combinations thereof. The applying 204 can be accomplished by spraying, pouring or other means of contacting the treatment composition and seeds. Applying 204 a treatment composition can be performed at an end amount of about 4-5 grams/acre, about 2-5 gms/a, about 5-35 gms/a, about 25-70 gms/a, about 45-95 gms/a, about 75-140 gms/a, about 100-500 gms/a or about 5-5000 gms/a, for example. Seed pre-treatment can be carried out at an off-site facility, on-site at the farm, or on-board planting equipment immediately prior to planting.

The treatment composition can be combined with one or more pesticides, including herbicides, insecticides, fungicides, and adherents, including commercial products, without negatively affecting the commercial product or seeds. The adherent can be a polymer (e.g., polysaccharide) such as a biocompatible and biodegradable adhesive material used in agricultural settings.

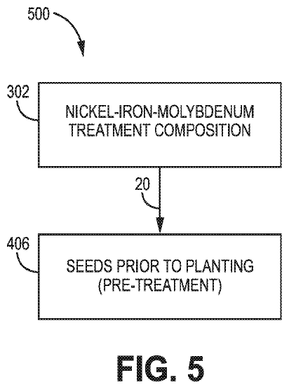

FIG. 5 is a flowchart of a method 500 of using a nickel-iron-molybdenum treatment composition in pre-treatment of seeds, according to one or more embodiments of the present disclosure. One Or more nickel-iron-molybdenum treatment compositions 302 can be applied 204 to one or more seeds prior to planting, such as in a pre-treatment stage 406.

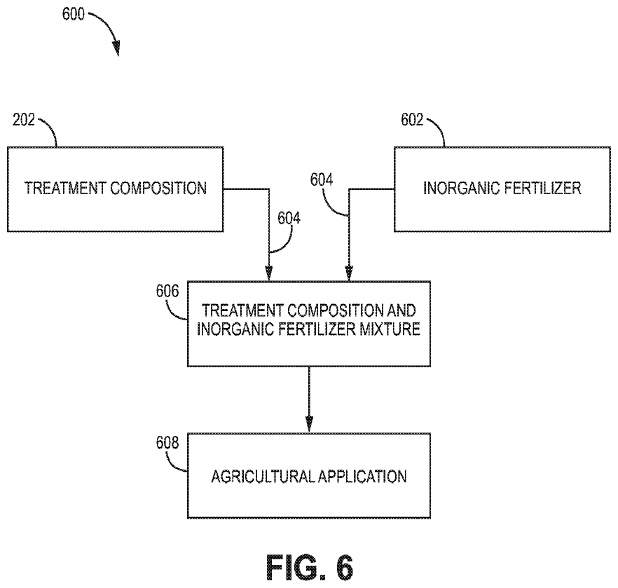

FIG. 6 is a flowchart of a method 600 of using a treatment composition and inorganic fertilizer mixture, according to one or more embodiments of the present disclosure. The treatment composition 202 can be contacted 604 or mixed with one or more inorganic fertilizers 602, sufficient to form a mixture 606. The mixture 606 can be used in an agricultural application 608. The applying the mixture in an agricultural application 608 can include one or more of applying to foliar, broadcasting on soil, tilling in soil, and in-furrow.

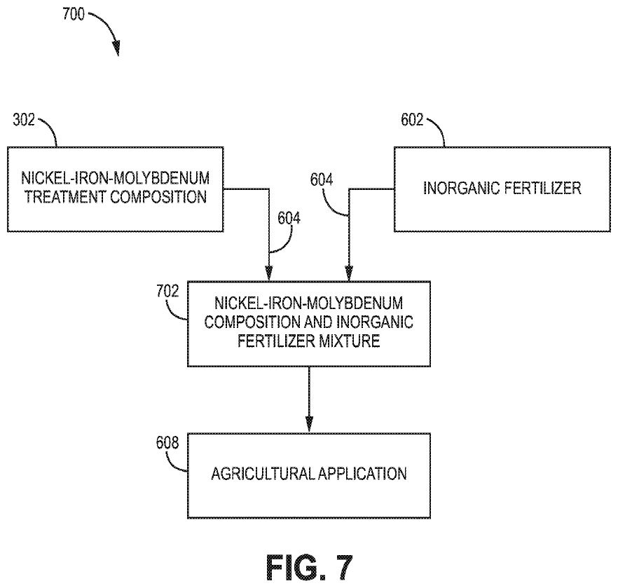

FIG. 7 is a flowchart of a method 700 of using a nickel-iron-molybdenum treatment composition and inorganic fertilizer mixture, according to one or more embodiments of the present disclosure. The nickel-iron-molybdenum treatment composition 302 can be contacted 605 or mixed with one or more inorganic fertilizers 602, sufficient to form a mixture 702. The mixture 702 can be used in an agricultural application 608.

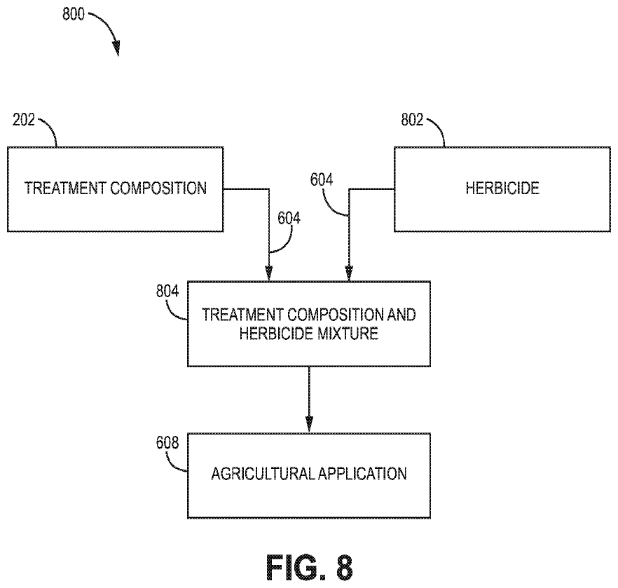

FIG. 8 is a flowchart of a method 800 of using a treatment composition and herbicide mixture, according to one or more embodiments of the present disclosure. The treatment composition 202 can be contacted 604 or mixed with one or more herbicides 802, sufficient to form a mixture 804. The mixture 804 can be used in an agricultural application.

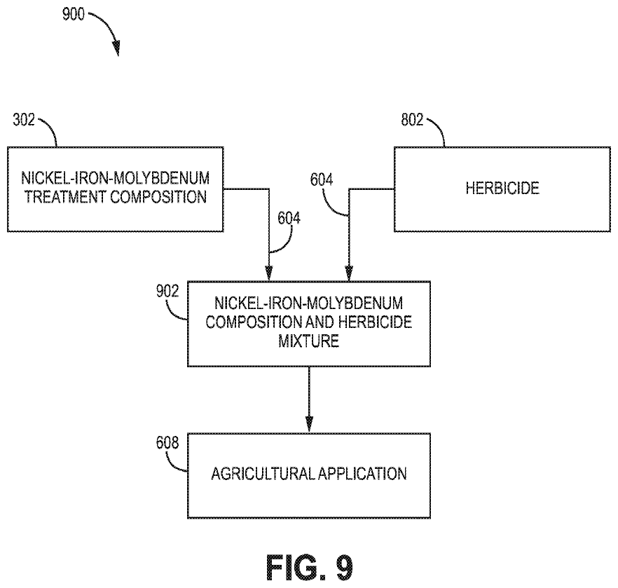

FIG. 9 is a flowchart of a method 900 of using a nickel-iron-molybdenum treatment composition and herbicide mixture, according to one or more embodiments of the present disclosure. The nickel-iron-molybdenum treatment composition 302 can be contacted 604 or mixed with one or more herbicides 802, sufficient to form a mixture 902. The mixture 902 can be used in an agricultural application.

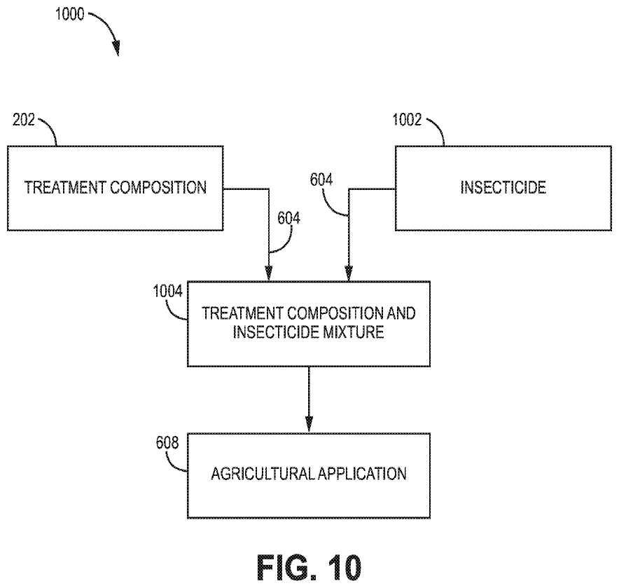

FIG. 10 is a flowchart of a method 1000 of using a treatment composition and insecticide mixture, according to one or more embodiments of the present disclosure. The treatment composition 202 can be contacted 604 or mixed with one or more insecticides 1002, sufficient to form a mixture 1004. The mixture 1004 can be used in an agricultural application 608.

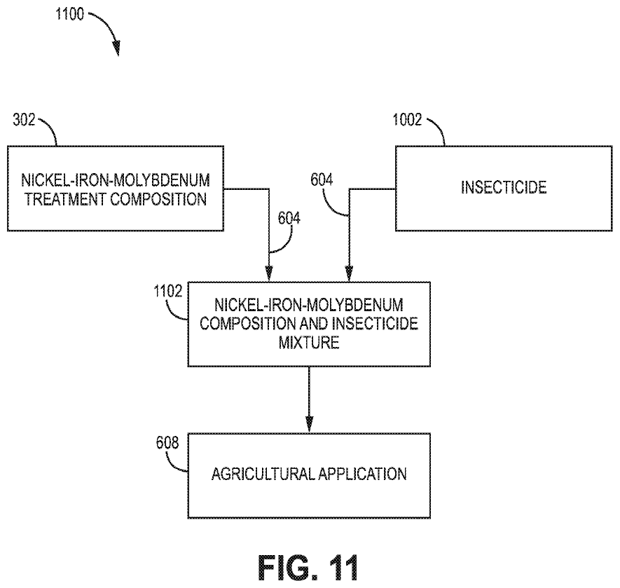

FIG. 11 is a flowchart of a method 1100 of using a nickel-iron-molybdenum treatment composition and insecticide mixture, according to one or more embodiments of the present disclosure. The nickel-iron-molybdenum treatment composition 302 can be contacted 604 with one or more insecticides 1002, sufficient to form a mixture 1102. The mixture 1102 can be used in an agricultural application 608.

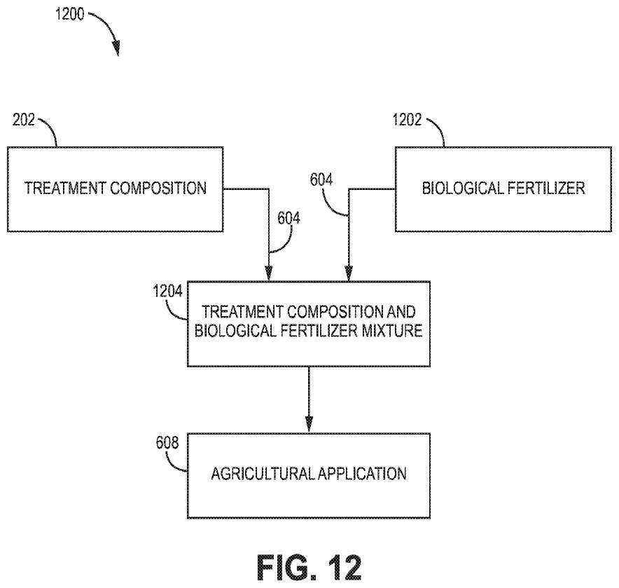

FIG. 12 is a flowchart of a method 1200 of using a treatment composition and biological fertilizer, according to one or more embodiments of the present disclosure. The treatment composition 202 can be contacted 604 or mixed with one or more biological fertilizers 1202, sufficient to form a mixture 1204. The mixture 1204 can be used in an agricultural application 608.

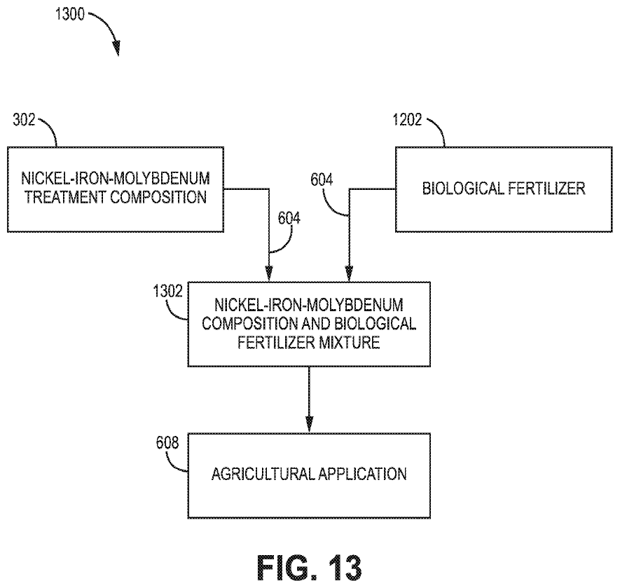

FIG. 13 is a flowchart of a method 1300 of using a nickel-iron-molybdenum treatment composition and biological fertilizer, according to one or more embodiments of the present disclosure. The nickel-iron-molybdenum treatment composition 302 can be contacted 604 or mixed with one or more biological fertilizers 1202, sufficient to form a mixture 1302. The mixture 1302 can be used in an agricultural application 608.

In some embodiments, a treatment method includes applying treatment compositions during multiple steps in a seed planting process. The treatment compositions can be applied to one or more seeds (e.g., a bag of seeds). The seeds are planted, and then the treatment compositions can optionally be re-applied in-furrow.

The following Examples are intended to illustrate the above invention and should not be construed as to narrow its scope. One skilled in the art will readily recognize that the Examiners suggest many other ways in which the invention could be practiced. It should be understand that numerous variations and modifications may be made while remaining within the scope of the invention.

Example formulations used in the following examples include Table 1 and Table 2. Table 2 utilizes an “in-tank reaction” to create nickel lactate as a final product.

TABLE 1

| Ingredient | %/wt | g | kilos | lbs |
|---|---|---|---|---|
| R.O. Water | 66.381 | 663.810 | 0.6638 | 1.463 |
| Ferric Ammonium | 30.300 | 303.00 | 0.3030 | 0.668 |
| Citrate (22.0% Fe) | | | | |
| Nickel(II) Lactate, | 1.495 | 14.950 | 0.0150 | 0.033 |
| Tetrahydrate (19% Ni) | | | | |
| Nickel(II) Sulfate, | 1.272 | 12.720 | 0.0127 | 0.028 |
| Hexahydrate (22.33% Ni) | | | | |
| Ammonium Molybdate(VI), | 0.552 | 5.520 | 0.0055 | 0.012 |
| Tetrahydrate (54.341% Mo) | | | | |
| Total | 100.00 | 1000.000 | 1.000 | 2.205 |

TABLE 2

| Ingredient | %/wt | g | kilos | lbs |
|---|---|---|---|---|
| R.O. Water | 65.306 | 653.060 | 0.6531 | 1.440 |
| Lactic Acid | 1.854 | 18.540 | 0.0185 | 0.041 |
| Nickel Hydroxy-Carbonate | 0.716 | 7.160 | 0.0072 | 0.016 |
| Paste (40% Ni) | | | | |
| ChemSol Nickel | 1.272 | 12.720 | 0.0127 | 0.028 |
| Sulfate Crystal (22.3% Ni) | | | | |
| Ferric Ammonium | 30.300 | 303.000 | 0.3030 | 0.668 |
| Citrate (22.0% Fe) | | | | |
| Ammonium Molybdate(VI), | 0.552 | 5.520 | 0.0055 | 0.012 |
| Tetrahydrate (54.341% Mo) | | | | |
| Total | 100.00 | 1000.000 | 1.000 | 2.205 |

### Example 1

### Treatment Compositions in-Furrow in Field

Various treatment compositions were applied in-furrow to soy. The compositions included the following: nickel-iron-molybdenum treatment compositions (“Mineral In-Furrow” or “MIF”); MIF+in-furrow treatment; bioliquid (“BL”) at one-half pound per acre; BL+in-furrow treatment; MIF+BL; in-furrow treatment; MIF+BL+in-furrow treatment; check (no treatment). The treatment compositions were applied to soy on a farm and Triple C farm, with about 4 to about 5 months passing from the time of planting to harvesting. The farms included replicated strip trials with four replications, with a total of about 57 strips on both farms. Stand count was taken periodically in two locations per strip by counting plants in 17.5 feet of row. The leaf area was also measured on one full replication using the hand-held portable leaf area tool and measuring three plants per strip. In addition, other visual comparisons were noted, including, but not limited to, soil property, herbicide effect, canopy coverage, root size, plant color, plant height, plant stage, and nodule differences. Yield was weighed with a weigh wagon.

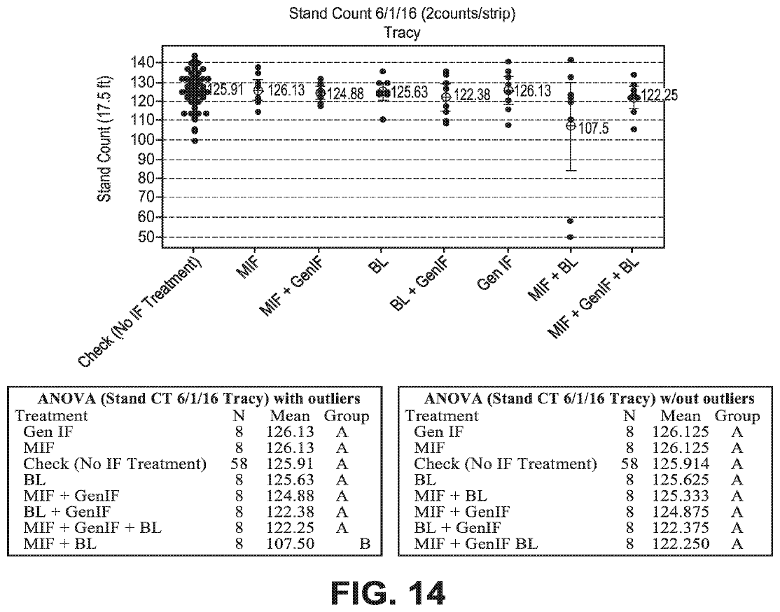

FIG. 14 is a graphical view of two stand counts from every strip, according to one or more embodiments of the present disclosure.

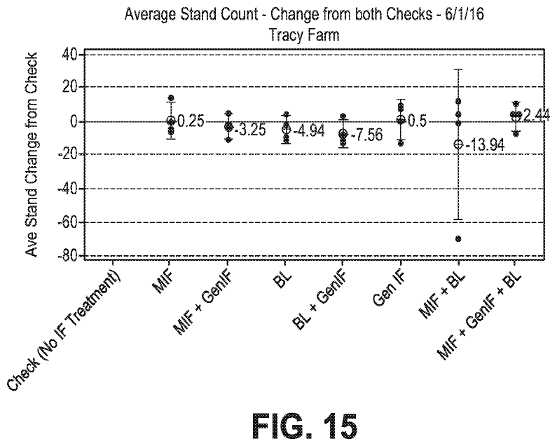

FIG. 15 is a graphical view of an average of two stand counts, according to one or more embodiments of the present disclosure.

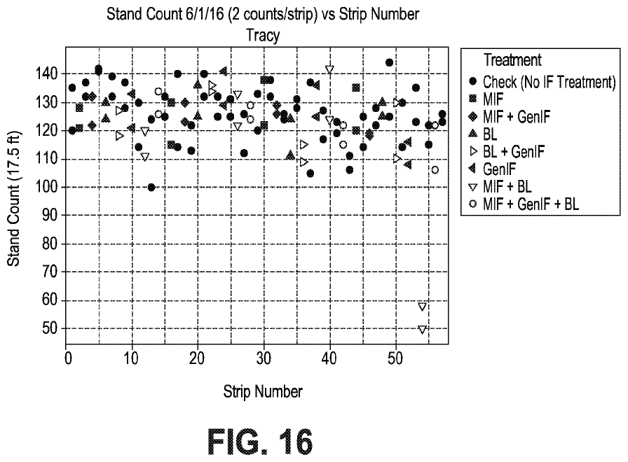

FIG. 16 is a graphical view of every data point collected for stand counts across the trial, according to one or more embodiments of the present disclosure.

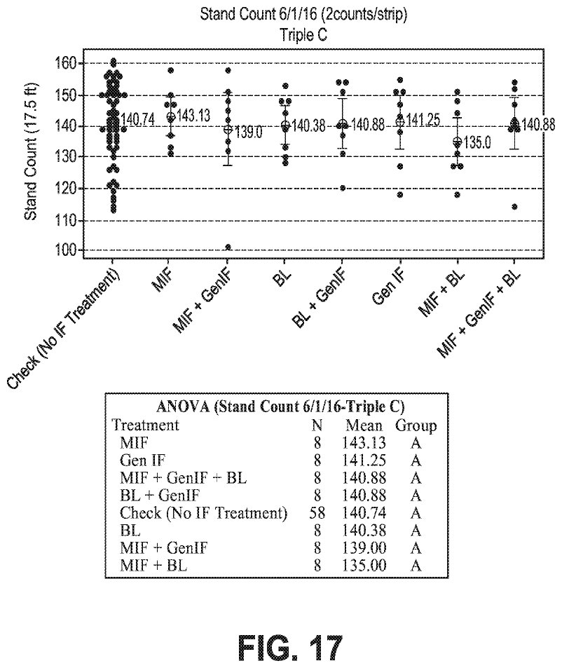

FIG. 17 is a graphical view of two stand counts from every strip, according to one or more embodiments of the present disclosure.

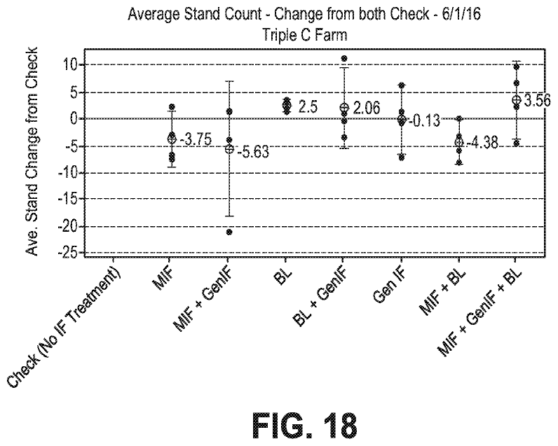

FIG. 18 is a graphical view of an average of two stand counts, according to one or more embodiments of the present disclosure.

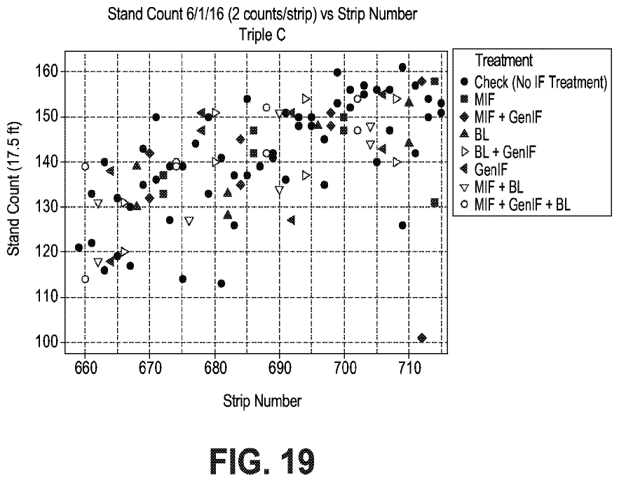

FIG. 19 is a graphical view of every data point collected from stand counts across the trial, according to one or more embodiments of the present disclosure.

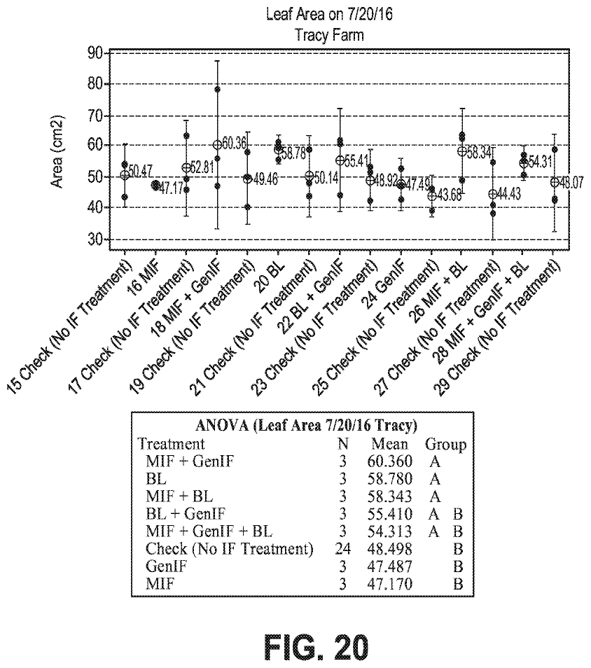

FIG. 20 is a graphical view of leaf area of three plants in every strip for one replication, according to one or more embodiments of the present disclosure.

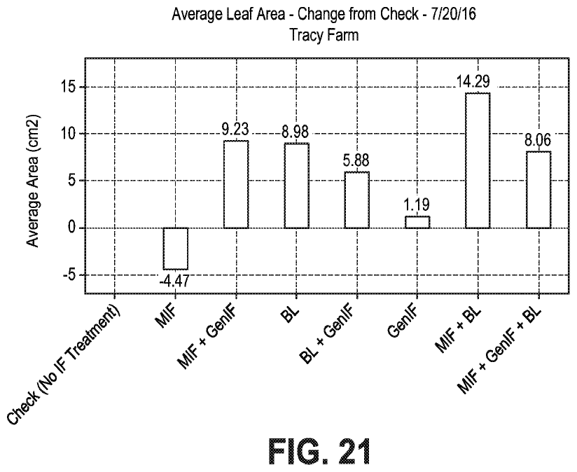

FIG. 21 is a graphical view of average leaf area of three plants, according to one or more embodiments of the present disclosure.

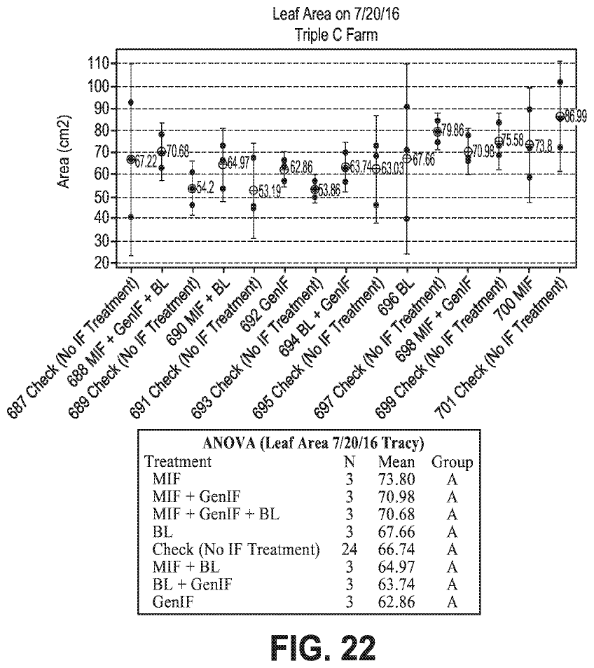

FIG. 22 is a graphical view of leaf area of three plants for every strip for one replication, according to one or more embodiments of the present disclosure.

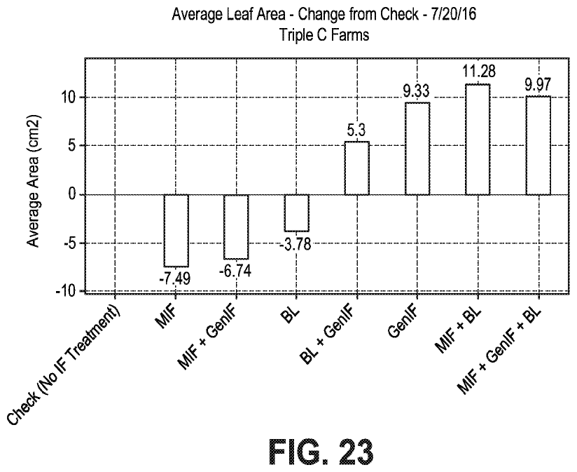

FIG. 23 is a graphical view of average leaf area of three plants, according to one or more embodiments of the present disclosure.

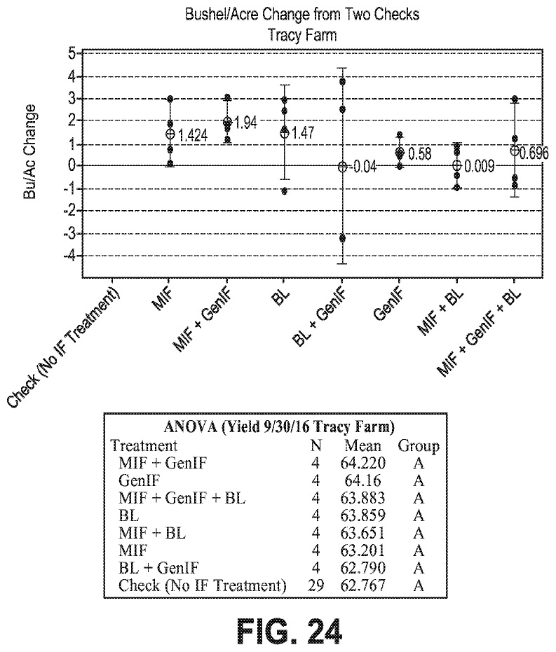

FIG. 24 is a graphical view of bushel/acre change from the average of the check on both sides (2 checks total), according to one or more embodiments of the present disclosure.

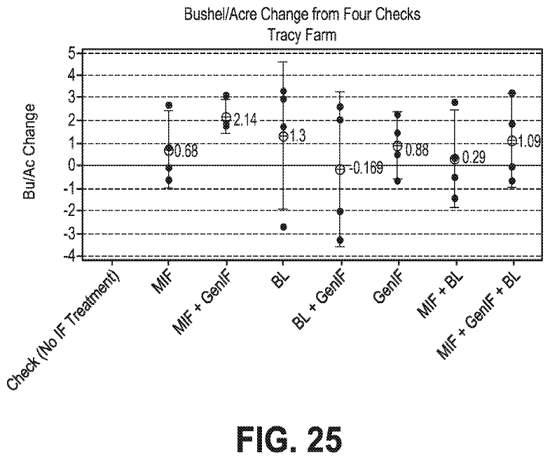

FIG. 25 is a graphical view of bushel/acre change from the average of two checks on both sides (4 checks total), according to one or more embodiments of the present disclosure.

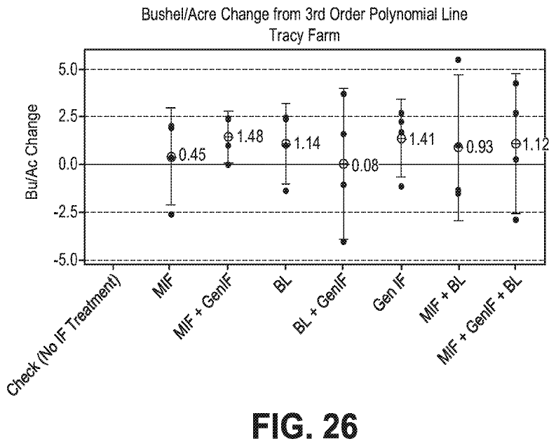

FIG. 26 is a graphical view of bushel/acre change from the slope of a third order polynomial line based off the checks, according to one or more embodiments of the present disclosure.

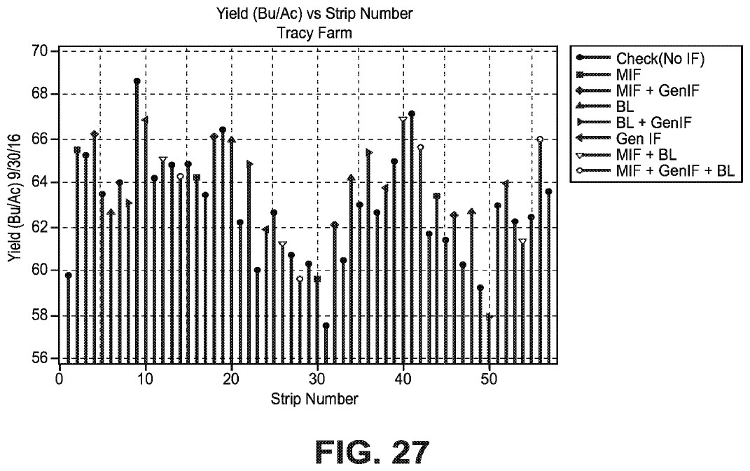

FIG. 27 is a scatter plot of the yield across the trial, with treatments indicated by individual colors, according to one or more embodiments of the present disclosure.

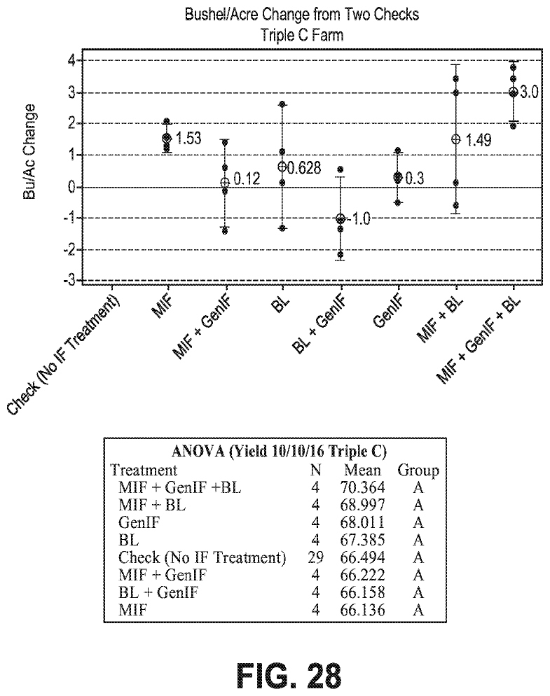

FIG. 28 is a graphical view of bushel/acre change from the average of the check on both sides (2 checks total), according to one or more embodiments of the present disclosure.

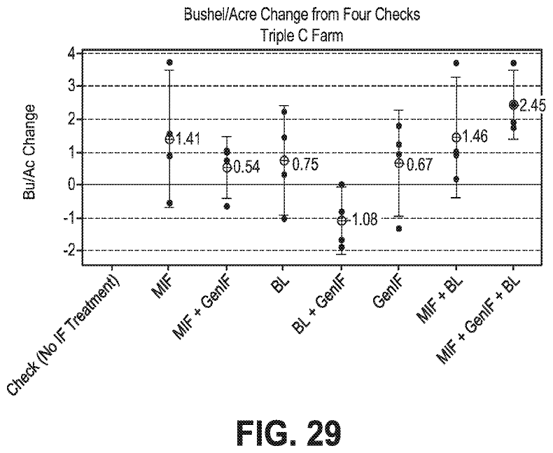

FIG. 29 is a graphical view of the bushel/acre change from the average of two checks on both sides (4 checks total), according to one or more embodiments of the present disclosure.

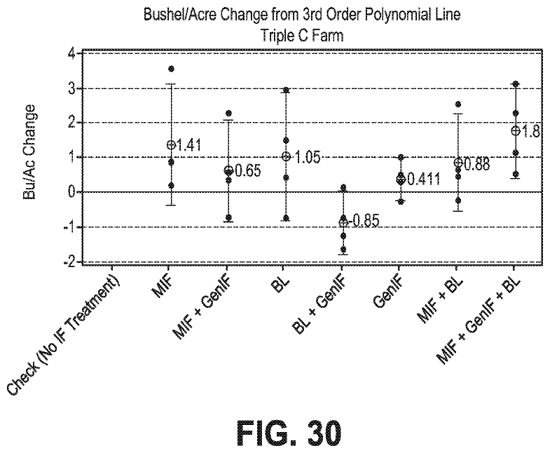

FIG. 30 is a graphical view of bushel/acre change from the slope of a third order polynomial line based off the checks, according to one or more embodiments of the present disclosure.

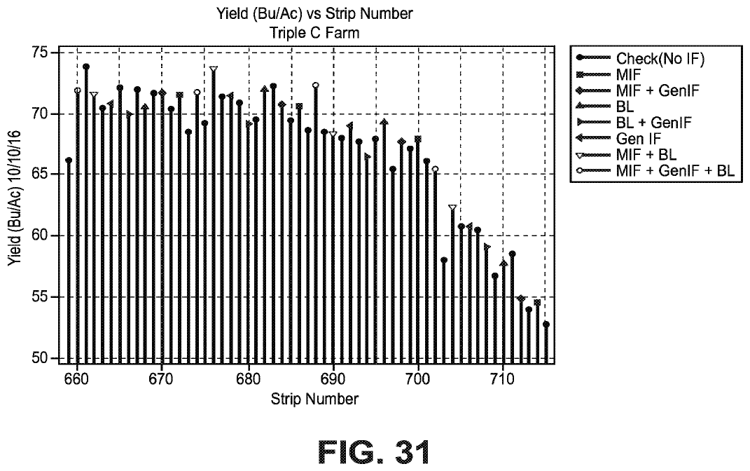

FIG. 31 is a scatter plot of the yield across the trial, with treatments indicated by individual colors, according to one or more embodiments of the present disclosure.

“Gen IF” and “MIF” performed the best with respect to stand count, when looking at the overall average of the treatments on both farms. However, when looking at the stand difference compared to the checks on either side of the treatments, the “MIF-GenIF-BL” treatment had the greatest stand increase over the check on both farms.

The leaf area statistically increased over the check on the farm by treatments with MIF+GenIF, BL, and MIF+BL. When looking at the difference between the checks on either side, all treatments had a greater leaf area than the check, with the exception of MIF. The greatest increase was from MIF+BL. On the Triple C farm, MIF and MIF+GenIF had the overall greatest leaf areas, however, when looking at the difference from the adjacent checks, those same two treatments had the greatest decrease in leaf area. Similar to the farm, the MIF+BL had the greatest increase in leaf area compared to the adjacent checks on the Triple C farm.

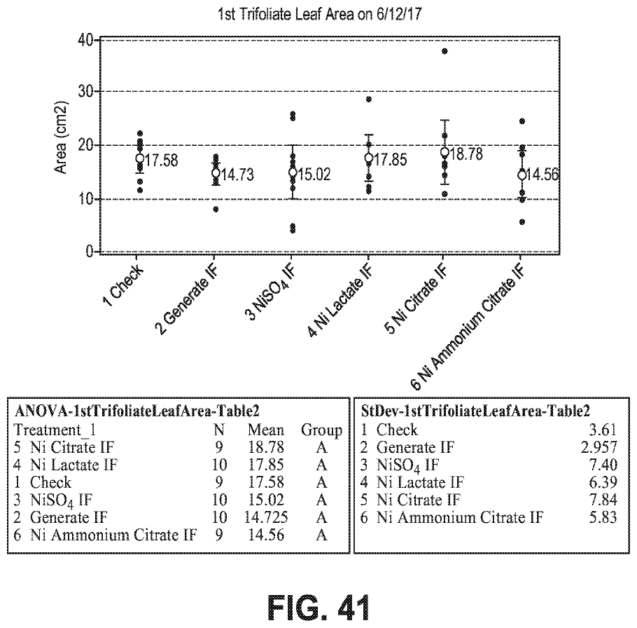

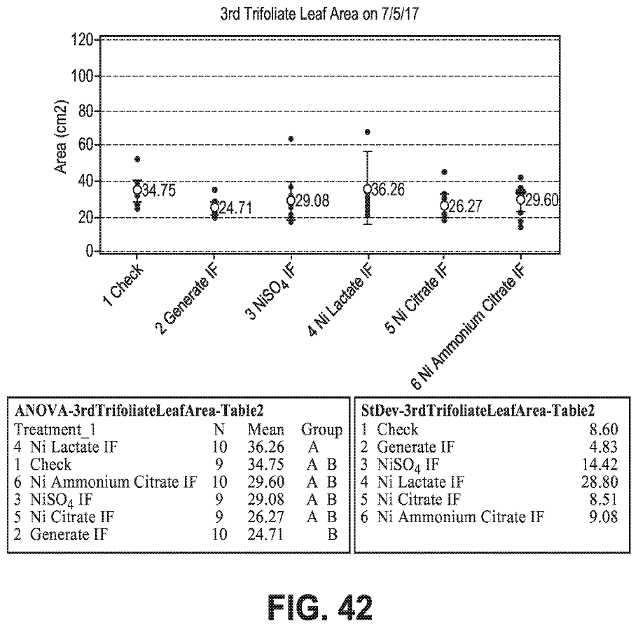

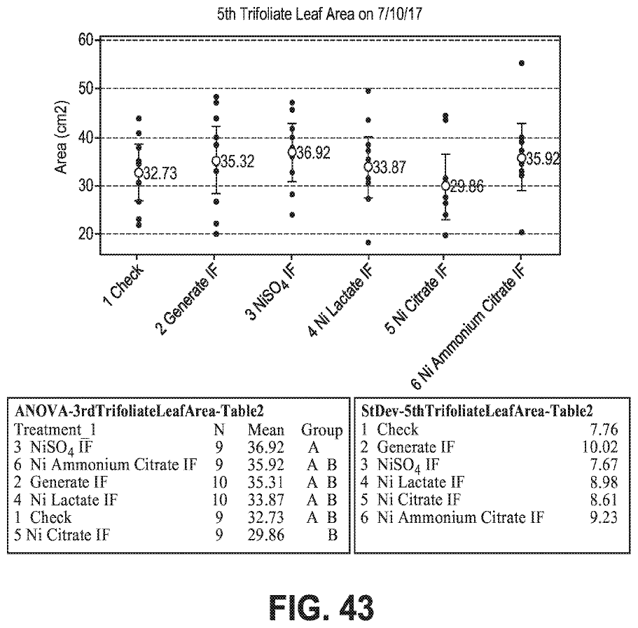

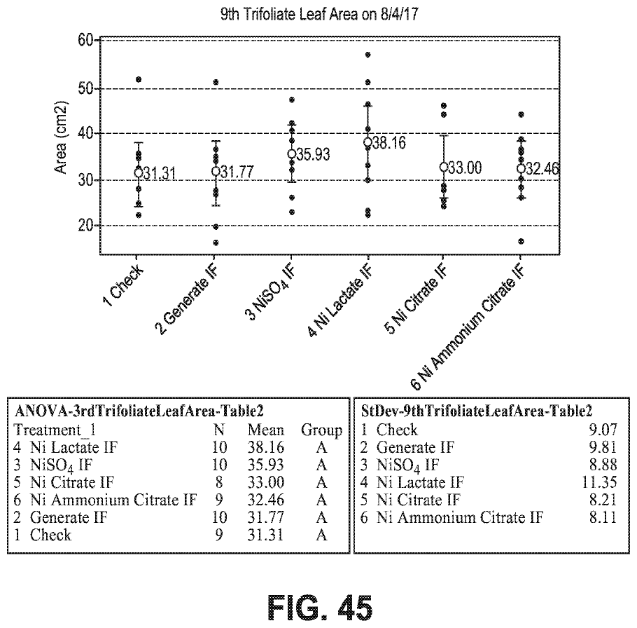

On the farm, the “check” had the lowest average yield and MIF+GenIF had the greatest yield increase as shown in FIGS. 41, 42, and 43. On the Triple C farm, the MIF+GenIF+BL had the greatest average yield across the whole trial, It also had the greatest yield in comparison to nearby checks as shown in FIGS. 45, 46, and 47. The last replication of this trial had a large drop in yield, which started right after MIF+GenIF+BL and affected all the other treatments and checks, which most likely gave MIF+GenIF+BL the advantage that caused it to outperform the other compositions.

### Example 2

### Treatment Compositions Applied in-Furrow and Foliar in Field

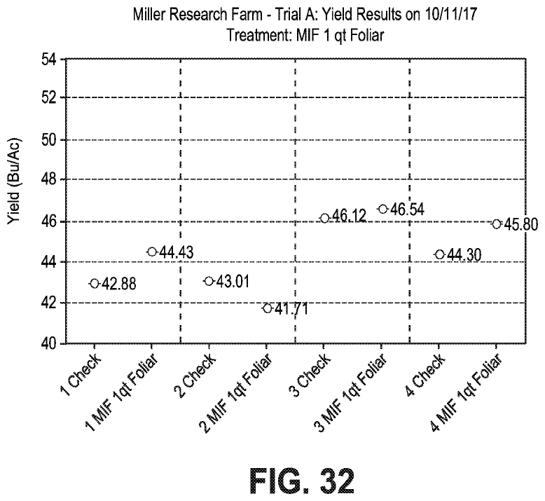

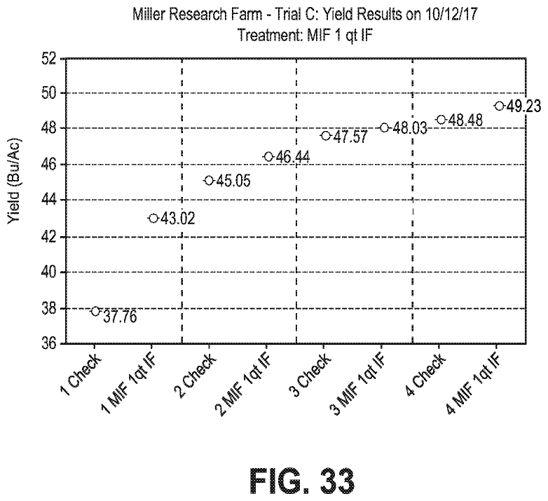

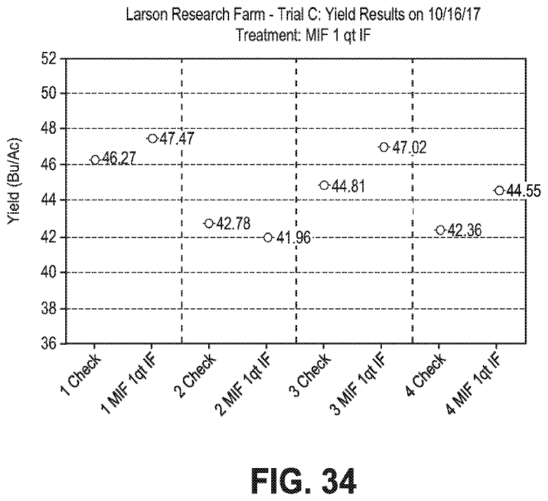

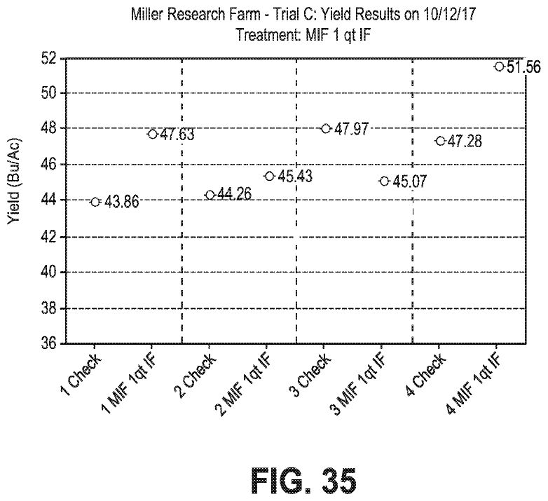

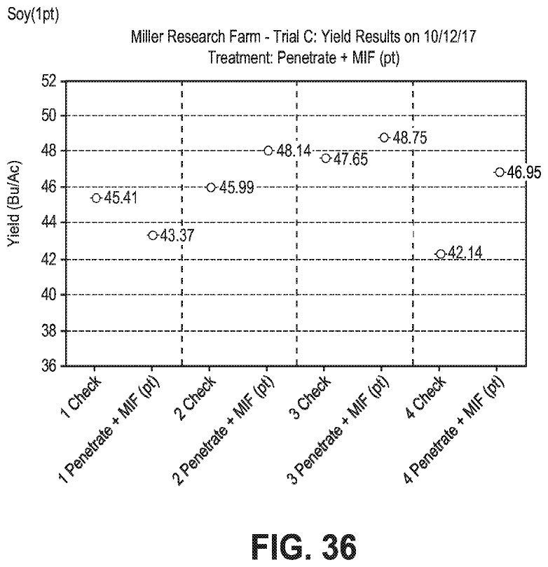

Various treatment compositions were applied foliar and in-furrow to soy, at an application rate of 1 quart per acre (FIGS. 32-34) and 1 pint per acre (FIGS. 35-36). FIGS. 32-36 are graphical views of the yield at four sections of a research farm, according to one or more embodiments of the present disclosure. FIG. 32 shows the soybean yield for a nickel-iron-moly (MIF) foliar application, in field. The yield increased in three of four sections. FIG. 33 shows the soybean yield for MIF in an in-furrow application. The yield increased at all four collected points in the field. FIGS. 34-35 show additional fields with an in-furrow treatment, in which yield increased in three of the four sample points in each field. In FIG. 36, a commercial surfactant and bioliquid (BL) was utilized (Penetrate by DPI Global) with the MIF compositions.

### Example 3

### Treatment Compositions Applied in-Furrow and Foliar in Field

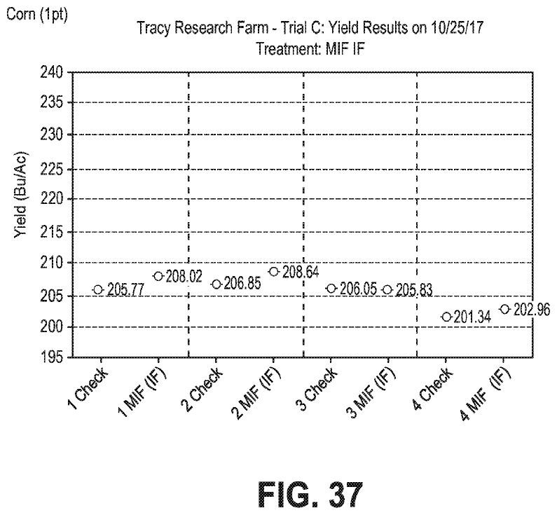

Various treatment compositions were applied in-furrow to corn, at an application rate of 1 pint per acre. FIG. 37 is a graphical view of the yield at four sections of a research farm, according to one or more embodiments of the present disclosure. The yield increased in three of the four sample points within the field.

### Example 4

### Treatment Compositions Applied in-Furrow to Soy Outside Greenhouse

The compositions applied to soy in-furrow include Generate, nickel sulfate, nickel lactate, nickel citrate, and nickel ammonium citrate. The Generate was applied at a rate one pint per acre. The remaining compositions were applied at a rate of five grams per acre. The soy was planted in May and harvested in October, with fertilizer applications in June and July.

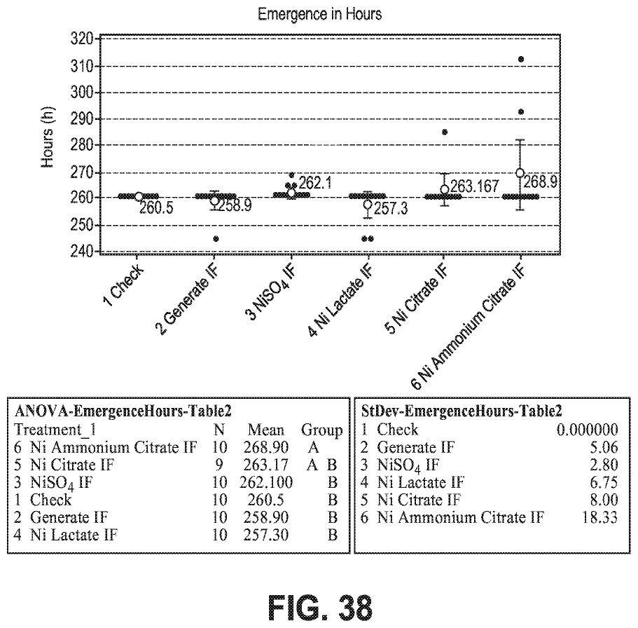

FIG. 38 is a graphical view of plant emergence, according to one or more embodiments of the present disclosure.

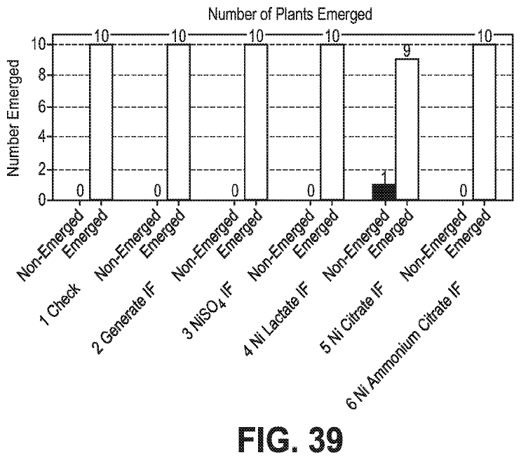

FIG. 39 is a graphical view of the number of plants emerged, according to one or more embodiments of the present disclosure.

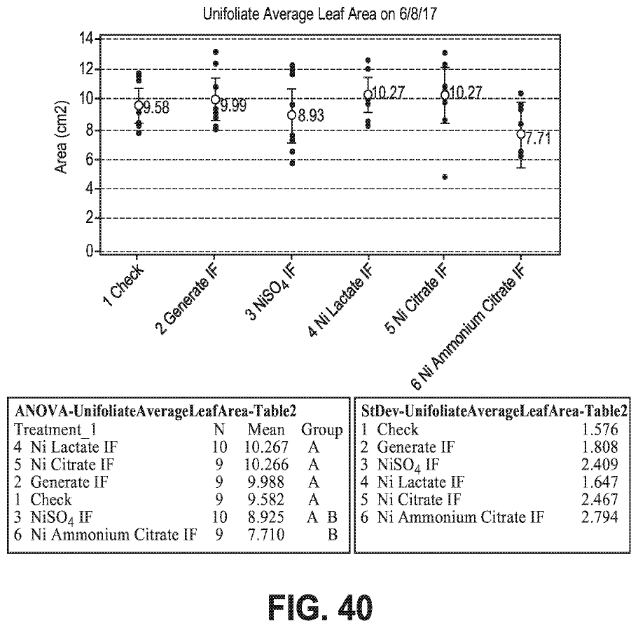

FIG. 40 is a graphical view of the unifoliate average leaf area, according to one or more embodiments of the present disclosure.

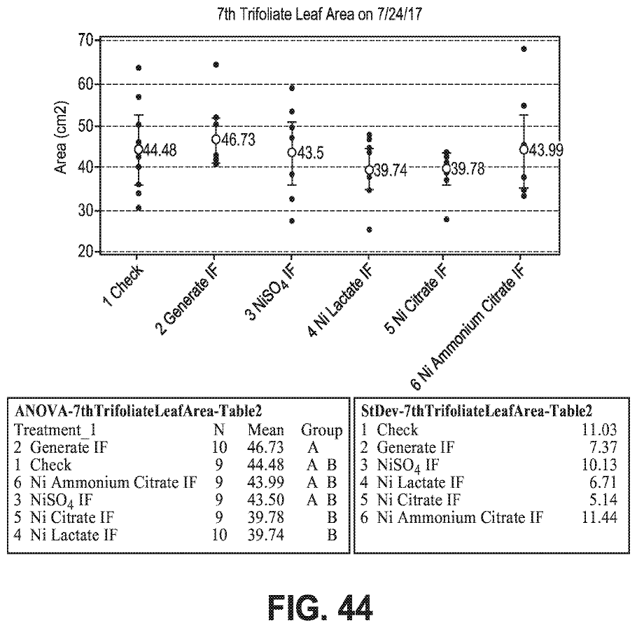

FIGS. 41-45 are graphical views of trifoliate leaf areas, according to one or more embodiments of the present disclosure.

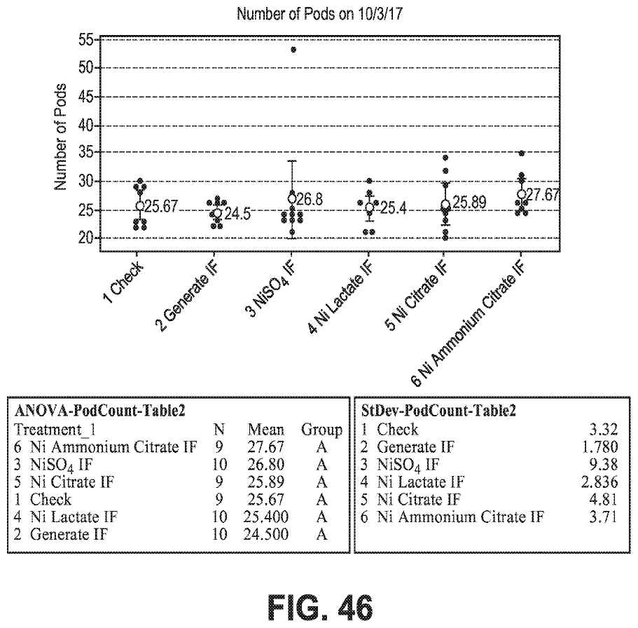

FIG. 46 is a graphical view of the number of pods, according to one or more embodiments of the present disclosure.

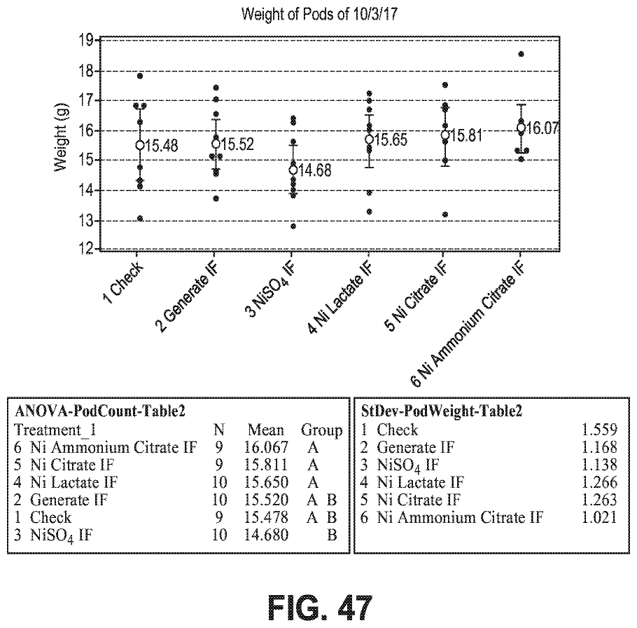

FIG. 47 is a graphical view of the weight of pods, according to one or more embodiments of the present disclosure.

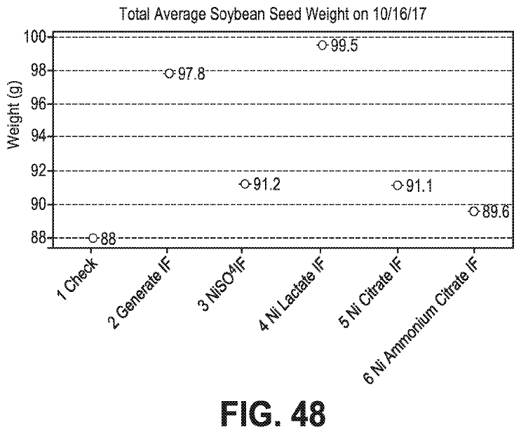

FIG. 48 is a graphical view of the total average soybean seed weight, according to one or more embodiments of the present disclosure.

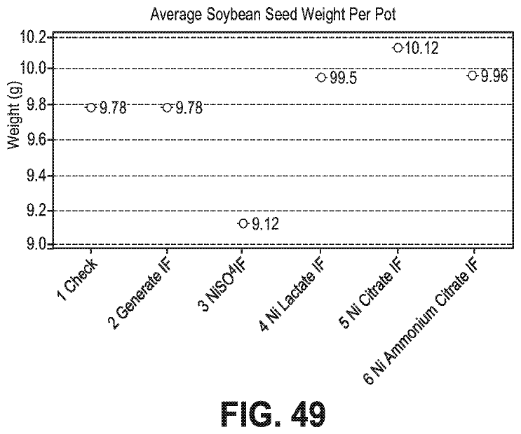

FIG. 49 is a graphical view of the average soybean weight per pot, according to one or more embodiments of the present disclosure.

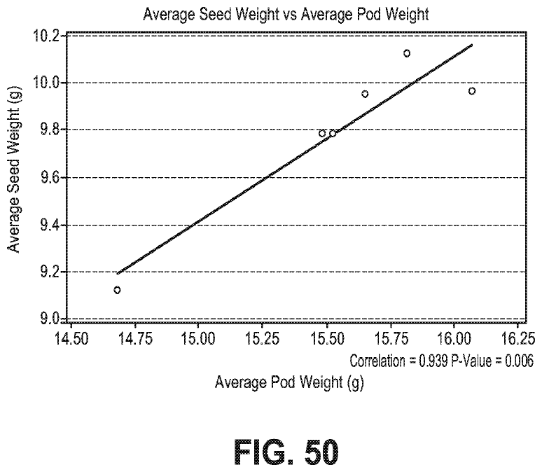

FIG. 50 is a graphical view of the average seed weight versus average pod weight, according to one or more embodiments of the present disclosure.

Various nickel compounds were tested and many were shown to display consistent benefits to soybeans. For example, FIG. 48 shows nickel lactate in-furrow application to increase total average soybean seed weight above the check (in addition to the other nickel compounds tested). In FIG. 49, the average soybean seed weight per pot also shows various nickel compounds (lactate, citrate, ammonium citrate) to increase seed weight over the check.

### Example 5

### Treatment Compositions Applied in-Furrow to Corn in Greenhouse

The compositions applied to corn in-furrow include FeNiMoMn at 0.5 pints/acre, FeNiMoMn at 1 pint/acre, FeNiMoMn at 1 quart/acre, FeNiMo at 1 pint/acre, and FeNiMo at 0.5 pint/acre with Generate at 0.5 pint/acre. The seeds were planted in January and harvested in May, and fertilized twice in March.

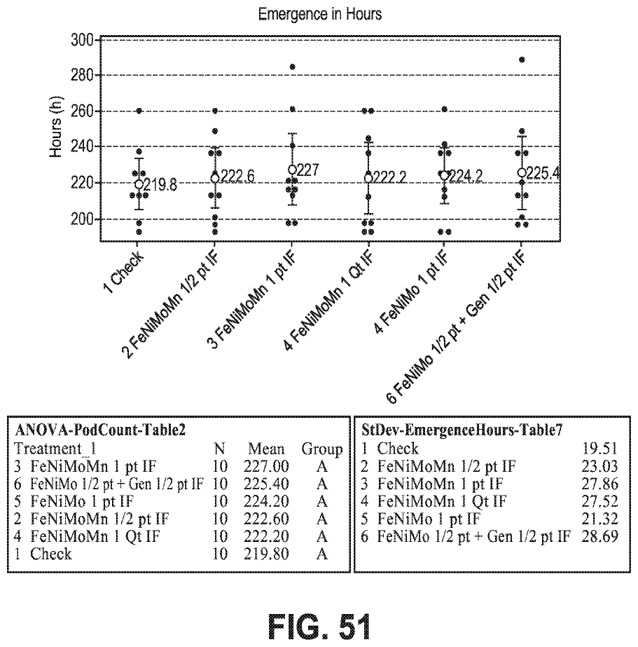

FIG. 51 is a graphical view of plant emergence, according to one or more embodiments of the present disclosure.

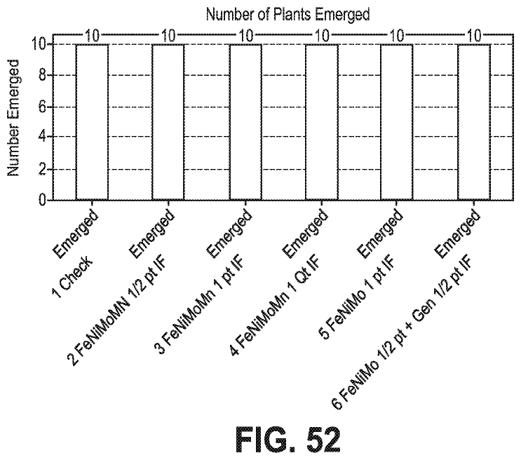

FIG. 52 is a graphical view of the number of plants emerged, according to one or more embodiments of the present disclosure.

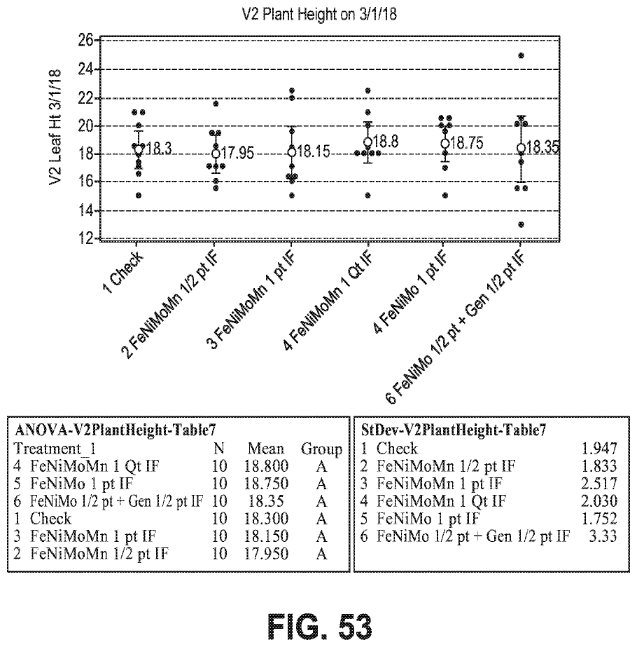

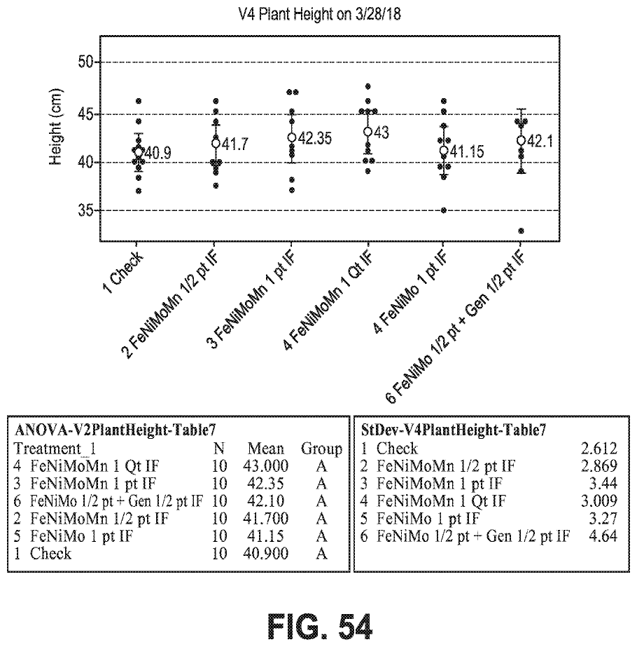

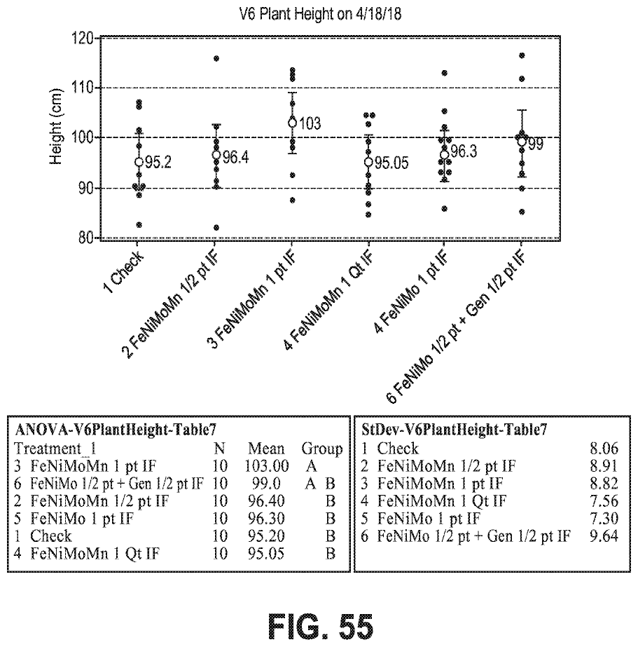

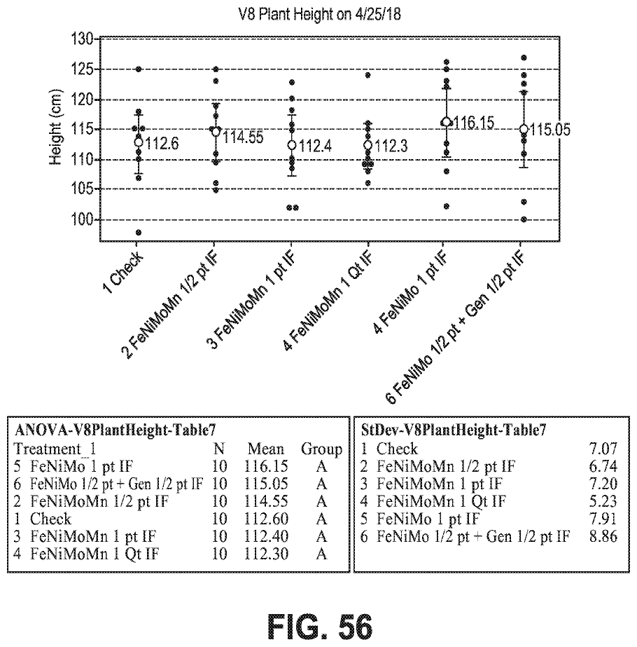

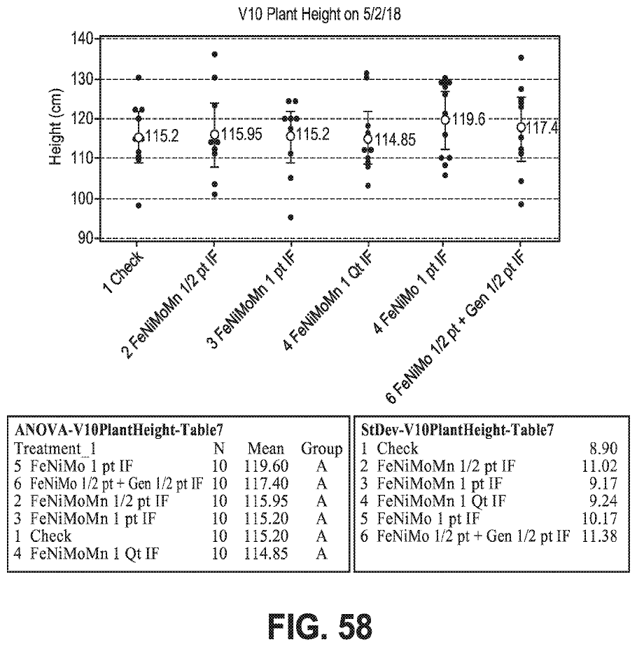

FIGS. 53-56, 58 are graphical views of plant height, according to one or more embodiments of the present disclosure.

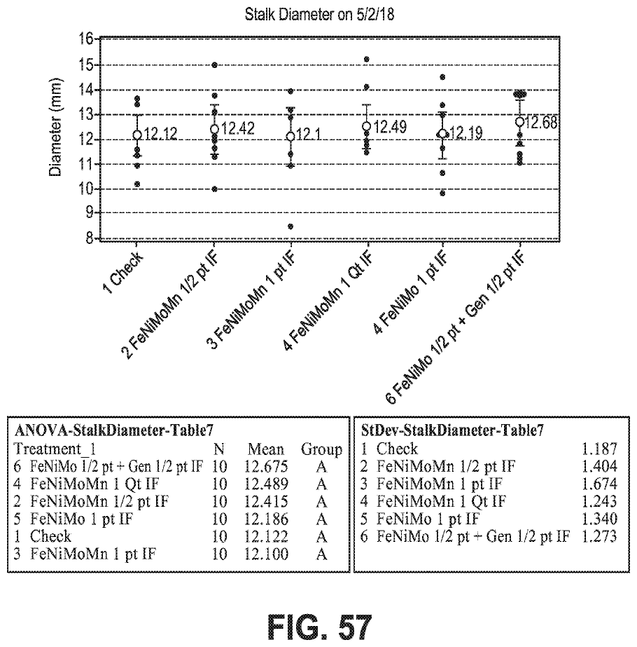

FIG. 57 is a graphical view of stalk diameter, according to one or more embodiments of the present disclosure.

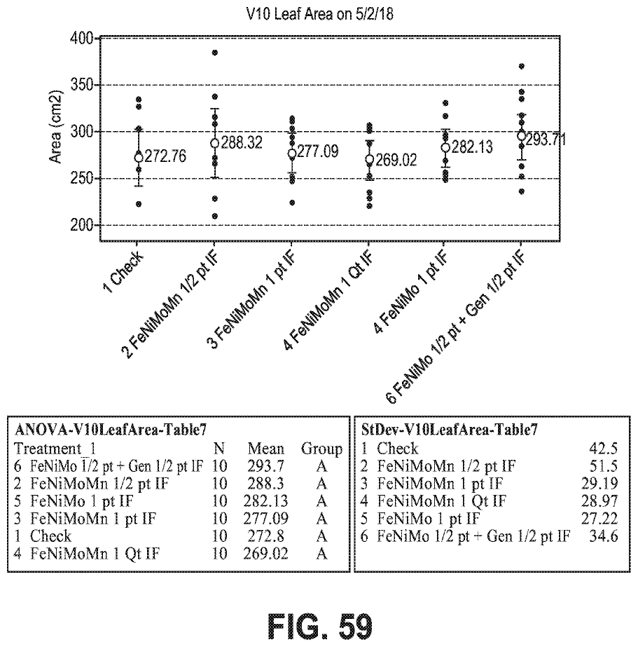

FIG. 59 is a graphical view of leaf area, according to one or more embodiments of the present disclosure.

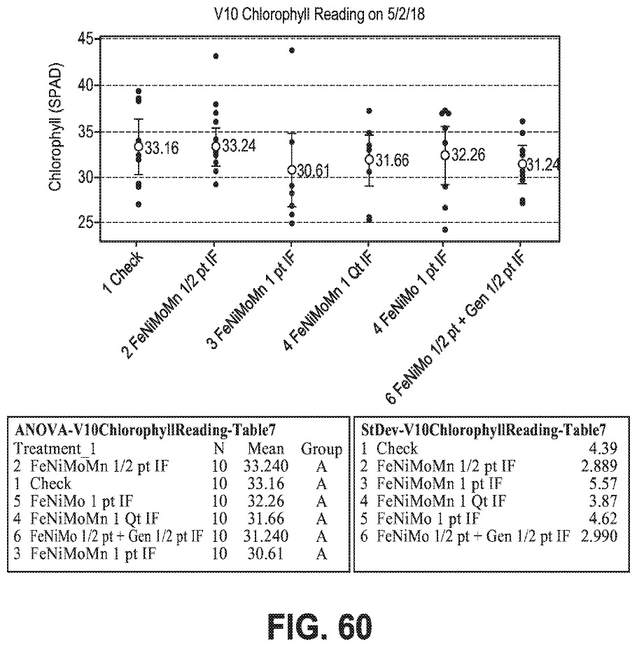

FIG. 60 is a graphical view of chlorophyll levels, according to one or more embodiments of the present disclosure.

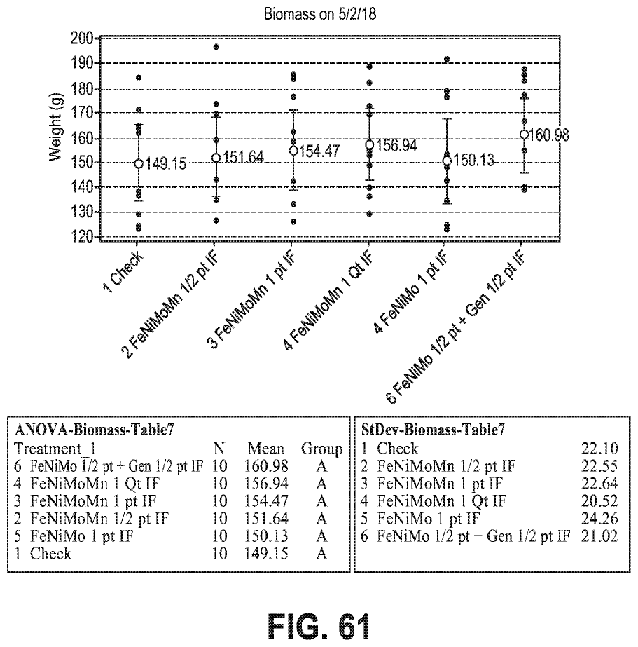

FIG. 61 is a graphical view of biomass measured, according to one or more embodiments of the present disclosure.

Manganese compounds were tested in combinations with nickel-iron-molybdenum compounds for corn.

### Example 6

### Treatment Compositions Applied Foliar to Soy Outside Greenhouse

The compositions applied to corn in-furrow include manganese lactate, manganese ammonium citrate, manganese lactate with manganese ammonium citrate, boron ester with manganese lactate, and boron ester with manganese lactate and manganese ammonium citrate. All were applied at ¼ pound/acre. The seeds were planted in May, harvested in October and fertilized in June and July. Boron and manganese were sprayed separately.

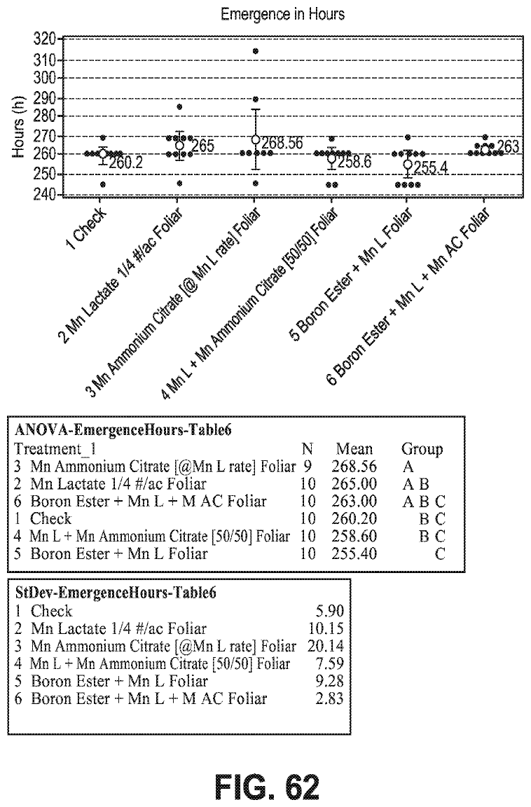

FIG. 62 is a graphical view of plant emergence, according to one or more embodiments of the present disclosure.

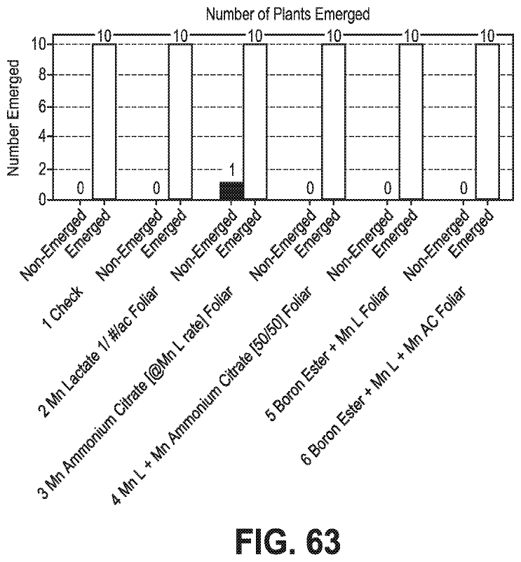

FIG. 63 is a graphical view of the number of plants emerged, according to one or more embodiments of the present disclosure.

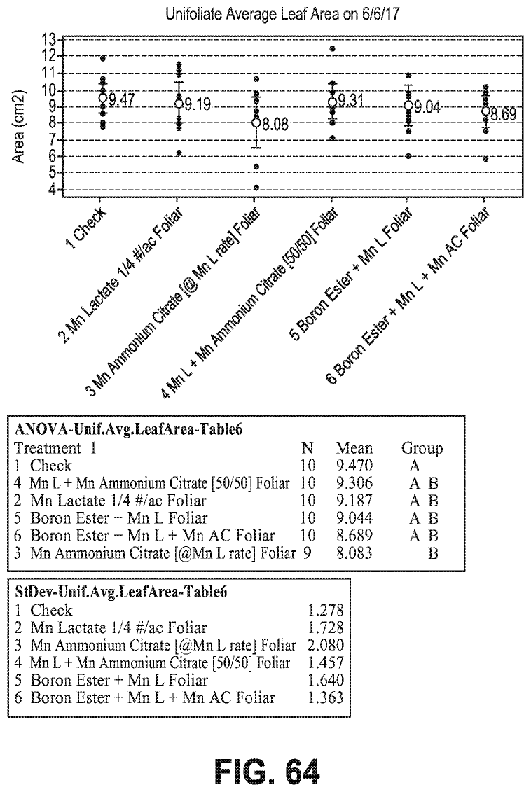

FIG. 64 is a graphical view of unifoliate average leaf area, according to one or more embodiments of the present disclosure.

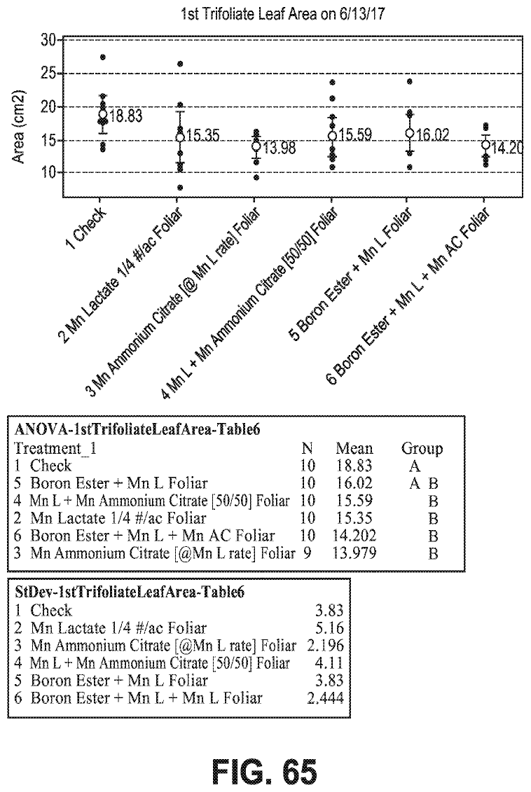

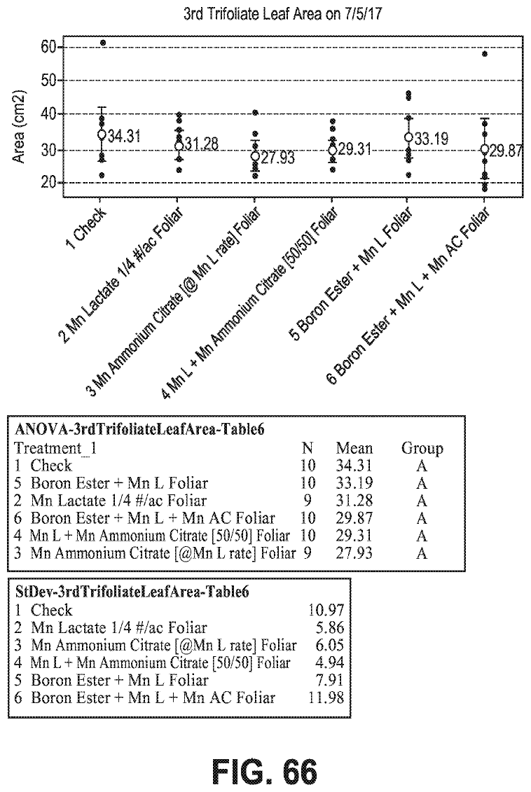

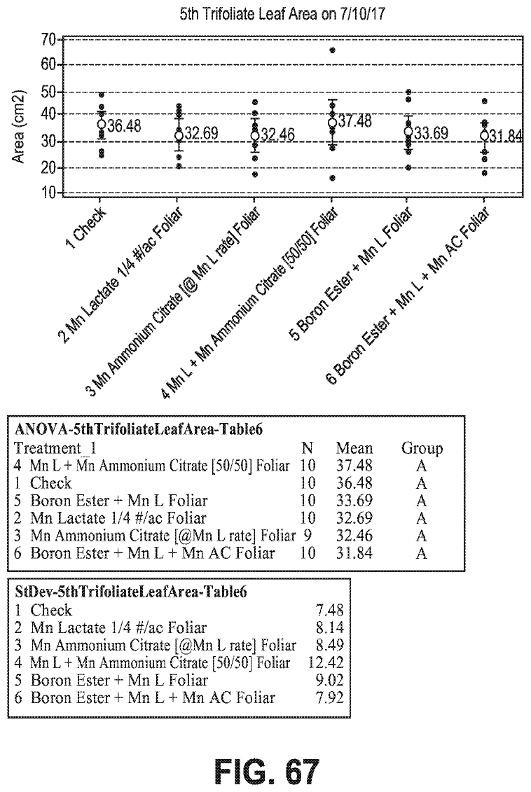

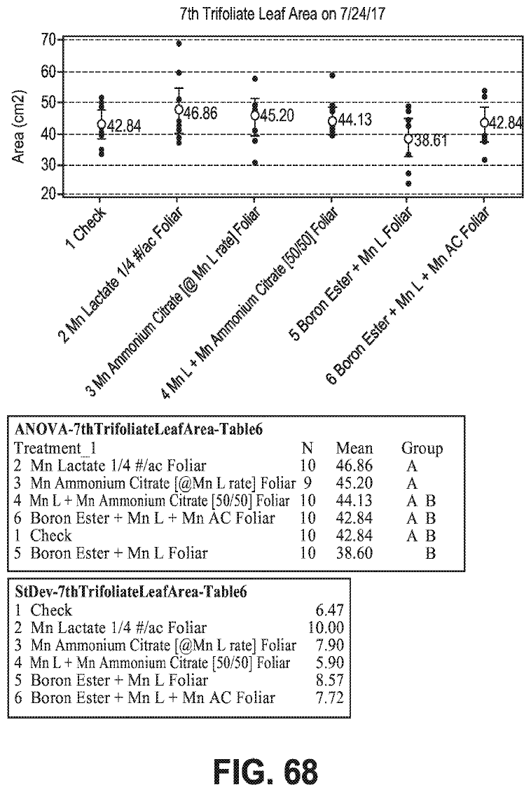

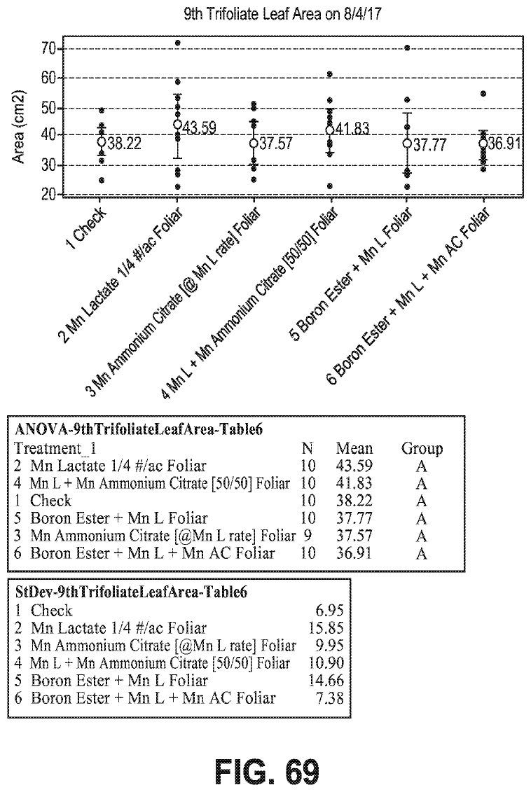

FIGS. 65-69 are graphical views of trifoliate leaf areas, according to one or more embodiments of the present disclosure.

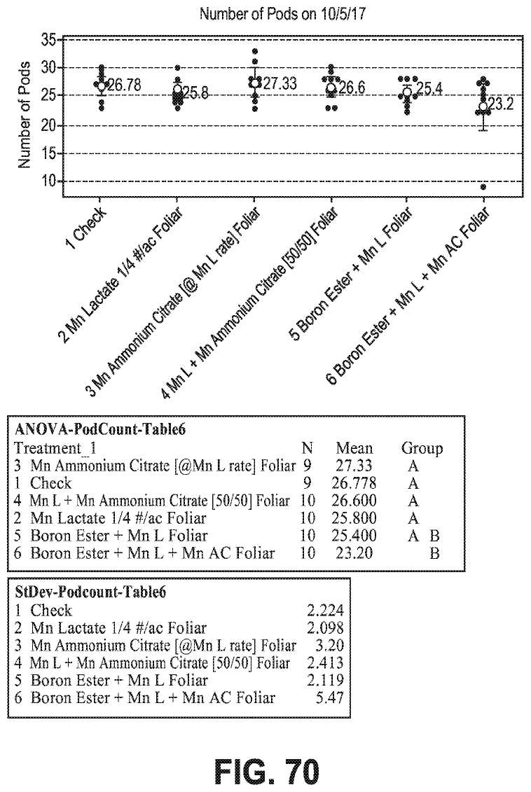

FIG. 70 is a graphical view of the number of pods, according to one or more embodiments of the present disclosure.

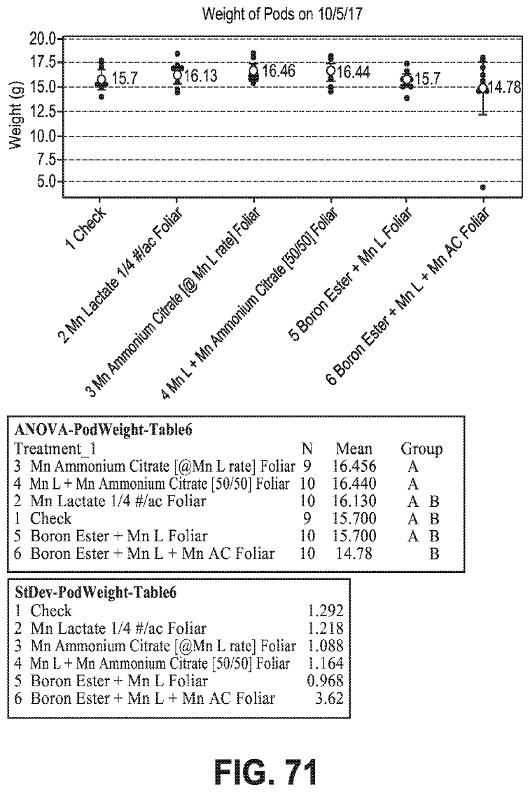

FIG. 71 is a graphical view of the weight of pods, according to one or more embodiments of the present disclosure.

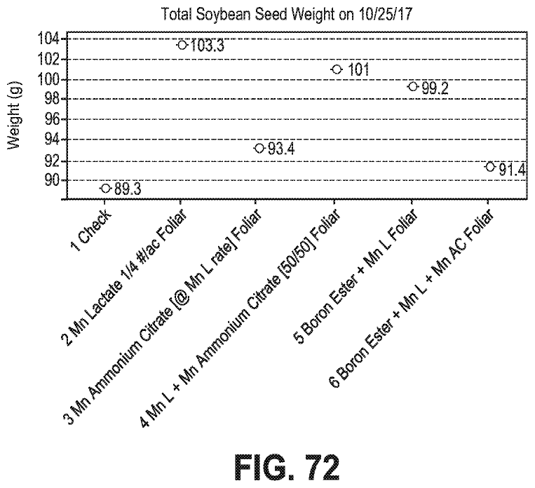

FIG. 72 is a graphical view of the total soybean seed weight, according to one or more embodiments of the present disclosure.

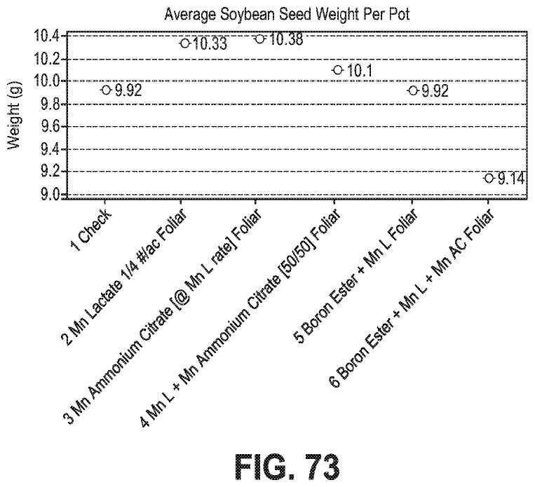

FIG. 73 is a graphical view of the average soybean seed weight per pot, according to one or more embodiments of the present disclosure.

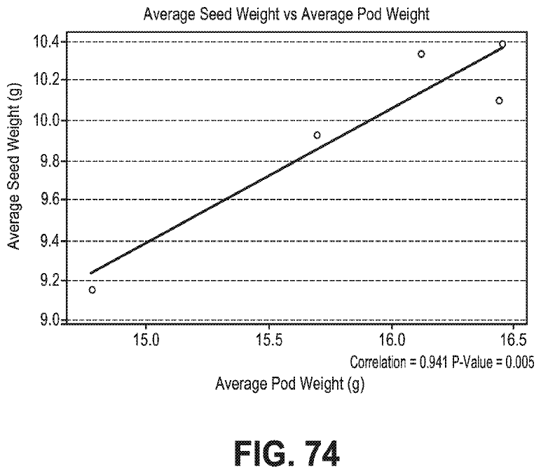

FIG. 74 is a graphical view of the average seed weight versus average pod weight, according to one or more embodiments of the present disclosure.

In FIG. 72 for example, various compounds utilized manganese increased the total soybean seed weight above the check.

Other embodiments of the present disclosure are possible. Although the description above contains much specificity, these should not be construed as limiting the scope of the disclosure, but as merely providing illustrations of some of the presently preferred embodiments of this disclosure. It is also contemplated that various combinations or sub-combinations of the specific features and aspects of the embodiments may be made and still fall within the scope of this disclosure. It should be understood that various features and aspects of the disclosed embodiments can be combined with or substituted for one another in order to form various embodiments. Thus, it is intended that the scope of at least some of the present disclosure should not be limited by the particular disclosed embodiments described above.

Thus the scope of this disclosure should be determined by the appended claims and their legal equivalents. Therefore, it will be appreciated that the scope of the present disclosure fully encompasses other embodiments which may become obvious to those skilled in the art, and that the scope of the present disclosure is accordingly to be limited by nothing other than the appended claims, in which reference to an element in the singular is not intended to mean “one and only one” unless explicitly so stated, but rather “one or more.” All structural, chemical, and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the present disclosure, for it to be encompassed by the present claims. Furthermore, no element, component, or method step in the present disclosure is intended to be dedicated to the public regardless of whether the element, component, or method step is explicitly recited in the claims.

The foregoing description of various preferred embodiments of the disclosure have been presented for purposes of illustration and description. It is not intended to be exhaustive or to limit the disclosure to the precise embodiments, and obviously many modifications and variations are possible in light of the above teaching. The example embodiments, as described above, were chosen and described in order to best explain the principles of the disclosure and its practical application to thereby enable others skilled in the art to best utilize the disclosure in various embodiments and with various modifications as are suited to the particular use contemplated. It is intended that the scope of the disclosure be defined by the claims appended hereto

Various examples have been described. These and other examples are within the scope of the following claims.

What is claimed is:

1. A seed, soil, or plant treatment composition, comprising:
a nickel compound, and
an iron compound.

2. The treatment composition of claim 1, further comprising a molybdenum compound.

3. The treatment composition of claim 1, wherein the nickel compound is a nickel chelated compound and/or nickel salt.

4. The treatment composition of claim 2, wherein the chelate of the nickel chelated compound is one or more of lactate, ethylenediamine tetraacetate (EDTA), propionate, butyrate, and acetate.

5. The treatment composition of claim 1, wherein the nickel compound is one or more of nickel lactate and nickel sulfate.

6. The treatment composition of claim 1, wherein a concentration of the nickel compound is less than about 3 wt. %.

7. The treatment composition of claim 1, wherein the iron compound is ferric ammonium citrate.

8. The treatment composition of claim 1, wherein a concentration of the iron compound is less than about 60 wt. %.

9. The treatment composition of claim 2, wherein the molybdenum compound is one or more of ammonium molybdate and molybdic acid.

10. The treatment composition of claim 2, wherein a concentration of the molybdenum compound is less than about 1 wt. %.

11. The treatment composition of claim 1, wherein the treatment composition improves one or more of plant emergence, crop yield, stand count, leaf area, root size, plant height, plant health, and plant resistance to disease and drought.

12. The treatment composition of claim 1, wherein the treatment composition is placed in-furrow, side-dressed in a field, used as a foliar treatment, broadcast on soil, and/or tilled in soil.

13. The treatment composition of claim 1, wherein the treatment composition is combined with one or more of a carrier, a solid carrier, a fiber, an enzyme, a pesticide, an insecticide, a fungicide, a herbicide, and a chelate or inorganic salt.

14. The treatment composition of claim 1, further comprising a manganese compound.

15. The treatment composition of claim 14, wherein the manganese compound is a manganese chelated compound and/or a manganese salt.

16. A seed, soil, or plant treatment composition, comprising:
nickel lactate.

17. The treatment composition of claim 16, further comprising an iron compound.

18. The treatment composition of claim 16, further comprising one or more of a molybdenum compound and manganese compound.

19. A method of preparing a seed, soil, or plant treatment composition,
comprising:
contacting a compound including nickel with a carboxylic acid to form a nickel chelated compound in solution,
adding one or more of an iron compound and a molybdenum compound to the solution, and
mixing the solution to form a seed, soil, or plant treatment composition.

20. The method of claim 19, wherein the carboxylic acid is one or more of lactic acid, EDTA, propionic acid, butyric acid, and acetic acid.

21. The method of claim 19 wherein the chelate of the nickel chelated compound is one or more of lactate, EDTA, propionate, butyrate, and acetate.

22. The method of claim 19, wherein the nickel chelated compound is one or more of nickel lactate and nickel sulfate.

23. The method of claim 19, wherein the iron compound is ferric ammonium citrate.

24. The method of claim 19, wherein the molybdenum compound is one or more of ammonium molybdate and molybdic acid.

25. The method of claim 19, further comprising adding one or more of a carrier, a solid carrier, a fiber, an enzyme, a pesticide, an insecticide, a fungicide, a herbicide, and a chelate or inorganic salt.

26. The method of claim 19, further comprising applying the seed, soil, or plant treatment composition, wherein applying includes one or more of place in-furrow, side-dress in a field, use as a foliar treatment, broadcast on soil, and till in soil.
